(19) United States
(12) Patent Application Publication
(10) Pub. No.: US 2007/0113602 A1
(43) Pub. Date: May 24, 2007

(54) Locks

(76) Inventor: John Russell Watts, Victoria (AU)

Correspondence Address: SUGHRUE MION, PLLC, 2100 PENNSYLVANIA AVENUE, N.W., SUITE 800, WASHINGTON, DC, 20037, US

(21) Appl. No.: 10/563,323

(22) PCT Filed: Jun. 10, 2004
(86) PCT No.: PCT/AU04/00764

§ 371 Date: Sep. 19, 2006

(30) Foreign Application Priority Data
Jul. 4, 2003 (AU) 2003903438
Jul. 10, 2003 (AU) 2003903585
Jul. 11, 2003 (AU) 2003903617
Jul. 17, 2003 (AU) 2003903718
Jul. 18, 2003 (AU) 2003903740
Jul. 21, 2003 (AU) 2003903786
Jul. 28, 2003 (AU) 2003903929
Aug. 11, 2003 (AU) 2003904266
Aug. 12, 2003 (AU) 2003904292
Sep. 16, 2003 (AU) 2003905043
Oct. 2, 2003 (AU) 2003905371
Oct. 15, 2003 (AU) 2003905634
Nov. 17, 2003 (AU) 2003906314
Nov. 18, 2003 (AU) 2003906607
Dec. 1, 2003 (AU) 2003906643
Jan. 12, 2004 (AU) 2004900111
Mar. 19, 2004 (AU) 2004901453
Apr. 4, 2004 (AU) 2004901824
Jun. 1, 2004 (AU) 2004903111

(51) Int. Cl. E05B 59/00

(52) U.S. Cl. 70/107

(57) ABSTRACT

A lock mountable to a displaceable wing (1) including a casing (5) and operating means including at least one hand operable unlatching lever (109) operable in an unlatching direction to cause a corresponding unlatching cam (101) to displace in an unlatching direction, an engaging member (7) supported by the casing and displaceable between a fully displaced disposition and a fully retracted disposition, the unlatching cam being operably connected to the engaging member by an angularly displaceable unlatching rocker (87) supported at a pivotal joint (333) disposed between the engaging member and the unlatching cam, the unlatching rocker having a first arm (88) operably associated with an unlatching arm of the unlatching cam and a substantially opposed second arm (90) operably associated with the engaging member, the unlatching cam being displaceable in an unlatching direction to cause unlatching arm to displace the first arm of the rocker to displace the second arm in the opposite direction to thereby cause the engaging member be displaced towards the fully retracted disposition. A lock as described above and including an angularly displaceable driver member (158) having an undisplaced disposition and being connectable to at least one remote engaging member to actuate the remote engaging member, said driver member being displaceable towards the undisplaced disposition by displacement of an unlatching cam in an unlatching direction, said driver member being displaceable from the undisplaced disposition by displacement of an unlatching cam in the opposite direction.

### BACKGROUND TO THE INVENTION

Aluminium framed French Doors, as defined below, typically employ a lock having a first portion that is morticed into the frame of the closing edge and handle assemblies that are mounted one on each side of the wing adjacent the first portion. Nowadays, these doors are often closed against a strip of compressible sealing material located between the door and an element defining in-part the opening and against which the wing closes (this strip being to prevent energy loss)—this action sometimes requiring a not insignificant force.

These doors can be urged in a closing direction by the inclusion of remote plunger-like members that are driven into receiving apertures of upper and lower elements of the opening and/or the inclusion of a lock having a suitably shaped bolt (described below) that is urged outwardly by the unlatching levers (as described below).

Typically locks for common French Doors comprise a first portion comprising a lock body of small depth and not more than about 40 MM, a small setback not exceeding about 30 MM, a small width not exceeding about 16 MM, a bolt that can extend at least 15 MM from the lock body and preferably means to displace rods at least 15 MM. Preferably, an industry standard for the distance between the cylinder and unlatching lever axii of 85.00 MM should also be observed. Typically locks for common Security Doors require the lock to have a smaller lock body having depth not exceeding about 40 MM, a setback of about 27 MM, a width of about 14.5 MM, a bolt that can extend at least 14 MM from the lock body and preferably means to drive rods or cables at least 11 MM. Preferably, the lock should also comply with the industry standard fitting apertures within the door.

In each case, it is difficult to comply with the space requirements imposed by the conditions described above because bolts need to extend adequately into the casing when fully extended to be properly supported and this imposes restrictions on integers competing for space adjacent the bolt and because the lock body must fit within a frame. These conditions place restrictions on the bolt, casing and other component depths and widths that also must observe minimum strength requirements. Furthermore, it is preferable that the locks comply with the Australian standards for Security Doors, Glass Doors, Locksets and Fire Doors—these standards defining minimum performance levels for strength, durability, corrosion resistance, ease of use and other functional and performance requirements.

Locks commonly employed in French doors in Australia do not provide compression, they are lockable only by key and it is not possible to lock the exterior unlatching lever while leaving the interior unlatching lever free to operated to enable egress and in many applications this is inconvenient and in some applications it is unsafe.

Locks commonly employed in security doors in Australia do have locking by interior locking lever (snib lever) but do not provide for locking of the exterior unlatching lever while retaining the interior unlatching lever free to be operated to enable egress.

The inventions herein, include locks that address the inadequacies described above.

The inventions herein, comprise improved complete locks and improvements for locks for displaceable wings that are not just limited to addressing the above described inadequacies of common Security and French Doors.

### Summary of the Invention Some Claims defining the Invention Are

According to the present invention there is a lock mountable to a displaceable wing including a casing and operating means including at least one hand operable unlatching lever operable in an unlatching direction to cause a corresponding unlatching cam to displace in an unlatching direction,

an engaging member supported by the casing and displaceable between a fully displaced disposition and a fully retracted disposition,

the unlatching cam being operably connected to the engaging member by an angularly displaceable unlatching rocker supported at a pivotal joint disposed between the engaging member and the unlatching cam, the unlatching rocker having a first arm operably associated with an unlatching arm of the unlatching cam and a substantially opposed second arm operably associated with the engaging member,

the unlatching cam being displaceable in an unlatching direction to cause unlatching arm to displace the first arm of the rocker to displace the second arm in the opposite direction to thereby cause the engaging member be displaced towards the fully retracted disposition.

In forms of the invention, the at least one unlatching lever comprises an angularly displaceable unlatching lever having a free end disposed from its pivotal axis, said free end being displaceable downwardly in an unlatching direction and displaceable upwardly in an opposite direction.

In forms of the invention, there is a displaceable deadlocking slide supported within the casing and characterized by a deadlocking configuration in which a leading end of the deadlocking slide and the engaging member co-operate to restrain the engaging member from being displaced from the fully displaced position.

In forms of the invention, the deadlocking configuration is characterized by an engaging shoulder of the deadlocking slide being behind an engageable shoulder of the engaging member.

In forms of the invention, there is a hand operable locking member operably connected to the deadlocking slide, the deadlocking slide being displaceable by the operation of the locking member.

In forms of the invention, the locking member is operably connected to the deadlocking slide by a locking cam supported within the casing.

In forms of the invention, the operating means comprises an interior unlatching cam corresponding to the interior unlatching lever and an exterior unlatching cam corresponding to the interior unlatching lever,

and wherein the locking member is operably connected to a lever locking cam supported within the exterior handle assembly,

said deadlocking slide being displaceable to the deadlocking configuration by the locking member simultaneously as the lever locking cam is displaced to a locking disposition where it causes the exterior unlatching lever to be restrained against displacement,

the deadlocking configuration being characterised by the second arm of the unlatching rocker being forward of a leading end of the deadlocking slide, the interior unlatching lever being displaceable to displace the interior unlatching cam to displace the unlatching rocker whereby to cause the second arm to contact the leading end of the deadlocking slide to displace the deadlocking slide away from deadlocking engagement to enable the engaging member to be displaced towards the fully retracted disposition while simultaneously causing the lever locking cam to be displaced from the locking disposition to free the exterior unlatching lever.

In forms of the invention, the leading end of the deadlocking slide includes the engaging shoulder and an adjacently disposed ramped unlocking shoulder, and wherein the deadlocking configuration is further characterized the ramped unlocking shoulder being behind a nose portion of the second arm of the unlatching rocker.

In forms of the invention, the unlocking shoulder is engageable by the nose portion to be displaced from the engaging member as the nose portion slides over the upwardly ramped edge defining the unlatching shoulder.

In forms of the invention, wherein the lever locking cam is displaced towards the locking configuration when the deadlocking slide is displaced to the deadlocking configuration, the locking of the exterior unlatching lever comprising displacement of a stop blade of a stop slide into a stop slot of a cupped member connected to the exterior unlatching lever, the stop slide being displaced towards the cupped member against biasing means by angular displacement of the lever locking cam, the angular displacement causing one of a pair engaging shoulders to slide over a lower substantially horizontally surface of the stop slide to enter a radially defined recess.

In forms of the invention, the lever locking cam is displaced in response to operation of the locking member.

In forms of the invention, the lever locking cam is displaced in response to displacement of the deadlocking slide by biasing means.

In forms of the invention, there is an angularly displaceable driver member having an undisplaced disposition and being connectable to at least one remote engaging member to actuate the remote engaging member,

said driver member being displaceable towards the undisplaced disposition by displacement of an unlatching cam in an unlatching direction, said driver member being displaceable from the undisplaced disposition by displacement of an unlatching cam in the opposite direction.

In forms of the invention, the pivotal axis of the diver member is substantially midway between the front and rear edges of the casing and orthogonal to the sides of the casing while the pivotal axis of the unlatching lever is parallel and rearwardly disposed of the driver member pivotal axis.

In forms of the invention, the pivotal axis of the unlatching cam is within the diameter that defines the periphery of the annular driver whereby to minimize the space within the casing occupied by the driver annulus and unlatching cam subassembly.

In forms of the invention, there is at least one remote engaging member vertically removed from the casing and operably connected to the driver member by a vertically elongated drive member resistant to buckling to be actuateable by unlatching lever displacement.

In forms of the invention, the diver member comprises a disc-like annular driver and wherein each unlatching cam includes a drive arm that extends to occupy a peripheral drive recess of the annular driver whereby to operably connect the unlatching cam and annular driver.

In forms of the invention, there is an upper and a lower remote engaging member each vertically removed from the casing, said remote engaging members being operably connected to the driver member by an upper vertically elongated drive member resistant to buckling hand a lower vertically elongated drive member resistant to buckling respectively to be simultaneously actuateable by unlatching lever displacement.

In forms of the invention, there is an upper drive member connected to a first side recess in the driver annulus adjacent the peripheral edge and a lower drive member connected to a radially opposed second side recess in the driver annulus adjacent the peripheral edge, the drive members being simultaneously displaceable in opposite directions in response to driver annulus rotation.

In forms of the invention, said upper drive member and lower drive member are connected to the driver annulus by an upper and a lower rectilinearly displaceable drive slide resistant to buckling h respectively, each said drive slide comprising a member resistant to buckling having at one end a right-angled return portion to mate within a side recess of the driver annulus and at the other end an externally threaded portion to mate with internal threading in an end of the corresponding drive member.

In forms of the invention, the externally threaded portion comprises a substantially cylindrical fitting having an axial aperture into which an offset extension of the drive slide extends to support the fitting.

In forms of the invention, there is for each drive member an elongated flexible cable attached to the fitting for threading through the unfitted drive member so that during fitting the drive member can be slid along the cable into the frame of the wing whereupon the cable can be pulled taunt to guide the threaded end of the drive member into contact with the fitting to be rotated into threaded engagement.

In forms of the invention, each drive member comprises a Bowden Cable having an inner cable having a right-angled return portion to mate within a side recess of the driver annulus peripheral edge.

In forms of the invention, the side recesses for the upper and lower inner Bowden Cables are adjacently disposed and the upper and lower inner Bowden Cables displace simultaneously in the same direction.

In forms of the invention, there is an angularly displaceable driver member comprising a disc-like annular driver connected to the deadlocking slide by a displaceable deadlocking slide extension and having an undisplaced disposition,

said driver member being connectable to at least one remote engaging member to be able actuate the remote engaging member, and member being

the driver member being displaceable towards the undisplaced disposition by displacement of the deadlocking slide from the deadlocking configuration and displaceable from the undisplaced disposition by displacement of the deadlocking slide towards the deadlocking configuration.

In forms of the invention, the pivotal axis of the diver member is substantially midway between the front and rear edges of the casing and orthogonal to the sides of the casing while the pivotal axis of the unlatching lever is parallel and rearwardly disposed of the driver member pivotal axis.

In forms of the invention, there is an upper and a lower remote engaging member each vertically removed from the casing, said remote engaging members being operably connected to the driver member by an upper vertically elongated drive member resistant to buckling h and a lower vertically elongated drive member resistant to buckling respectively to be simultaneously actuateable.

In forms of the invention, there is an upper drive member connected to a first side recess in the driver annulus adjacent the peripheral edge and a lower drive member connected to a radially opposed second side recess in the driver annulus adjacent the peripheral edge, the drive members being simultaneously displaceable in opposite directions in response to driver annulus rotation.

In forms of the invention, each drive members comprises a Bowden Cable having an inner cable having a right-angled return portion to mate within a side recess of the driver annulus peripheral edge.

In forms of the invention, the side recesses for the upper and lower inner Bowden Cables are adjacently disposed and the upper and lower inner Bowden Cables displace simultaneously in the same direction. In forms of the invention, there is a driver locking slide connected to the deadlocking slide to be displaced into a driver locking recess of the driver member when the deadlocking slide is displaced to the deadlocking configuration whereby to restrain the driver member against displacement.

In forms of the invention, there is a lock body mountable to a displaceable wing supported adjacent an opening and engageable means associated with an element defining in part the opening, said lock body including a casing and an engaging member supported by the casing and displaceable between a a fully displaced disposition corresponding to the engaging member and engaging means cooperating in engagement to restrain the wing against displacement in an opening direction and a fully retracted disposition in which it is not so engaged with the engageable means.

In forms of the invention, the engaging member is biased towards the fully displaced disposition and is characterized by a pre-latching configuration in which it is restrained from being displaced towards the fully displaced disposition.

In forms of the invention, there is an outwardly biased auxiliary bolt to cooperate with the engaging member to restrain the engaging member in the pre-latching configuration, said auxiliary bolt being inwardly displaceable to preclude said engagement.

In forms of the invention, the engaging member comprises a strike plate and wherein a portion of the latch bolt protrudes from the casing in the pre-latching configuration to be engaged on either side by the strike plate during latching to be inwardly displaced by the strike plate, said portion being similarly profiled on both sides, said profiling comprising a radius, curve or chamfer or other such form.

In forms of the invention, the engageable means comprises a strike plate and the wing comprises a hinged door or the like.

In forms of the invention, the engageable means comprises a catch and the wing comprises a sliding door or the like.

In forms of the invention, the engaging member comprises a rectilinearly displaceable latch bolt.

In forms of the invention, the latch bolt supports at least one displaceable hooking arm having an engaging shoulder that protrudes from a side of the bolt when the bolt is fully extended.

In forms of the invention, the engaging member comprises an angularly displaceable latch bolt.

In forms of the invention, the engaging member comprises a drive bolt that is outwardly displaceable by operation of each unlatching lever.

In forms of the invention, there is a hand operable locking member and a displaceable deadlocking slide supported within the casing and characterized by a deadlocking configuration in which a leading end of the deadlocking slide and the engaging member co-operate to restrain the engaging member from being displaced from the fully displaced position,

wherein the deadlocking slide is biased towards and displaceable into the deadlocking configuration by a deadlocking slide biasing means,

the deadlocking slide being displaceable from the deadlocking configuration by the locking cam to a spring-loaded restrained configuration where an arm of the locking cam overlaps an exit shoulder of the deadlocking slide,

the locking cam being displaceable subsequently to release the deadlocking slide to enable it to be displaced by deadlocking slide biasing means to abut the engaging member in the pre-latching configuration and where on latching to be displaced into the deadlocking configuration.

In forms of the invention, the deadlocking slide includes an accelerator to displace the locking cam to overlap the exit shoulder of the deadlocking slide.

In forms of the invention, there is a compression spring supported within a spring recess between a spring wing of the deadlocking slide and an end of the spring recess.

In forms of the invention, there is a key operable cylinder having an angularly displaceable cylinder cam having a cylinder cam arm that protrudes into a drive recess of the deadlocking slide to operably couple the deadlocking slide and cylinder to enable the deadlocking slide to be displaced into and out of the deadlocking configuration by the cylinder.

In forms of the invention, the cylinder arm is displaceable from the drive recess to abut an exit shoulder of the deadlocking slide when the lock is in a first locked configuration to restrain the deadlocking slide against displacement by means other than operation of the cylinder.

In forms of the invention, the deadlocking slide includes a slide spring having a spring arm that is displaced by the cylinder cam as it departs the drive recess, said slide spring biasing the cylinder cam arm against leaving the drive recess.

In forms of the invention, there is a stop pin to limit the displacement of the deadlocking slide whereby to restrict the first cam from leaving the drive recess.

In forms of the invention, the cylinder comprises a double free rotation cylinder.

In forms of the invention, the unlatching lever comprises a ball.

In forms of the invention, the unlatching lever comprises a lever having a radially protruding extension.

In forms of the invention, a fully displaced disposition embraces an operative disposition and a fully retracted disposition embraces an inoperative disposition.

According to the present invention, there are locks for displaceable wings substantially as described herein with reference to and as illustrated in the accompanying drawings.

According to the present invention, there are improved complete locks for displaceable wings and improvements for locks for displaceable wings substantially as described herein with reference to and as illustrated in the accompanying drawings.

### DESCRIPTION OF THE PREFERRED EMBODIMENTS

Definitions and Conventions Employed within the Body of the Specification and Claims that Follow:

This specification describes inventions comprising improved complete locks for displaceable wings and improvements for locks for displaceable wings that (for convenience) are referred to herein as “locks” and throughout this specification and claims which follow, unless the context requires otherwise, the word “locks” or variations such as “lock” will be understood to imply the inclusion of complete locks for displaceable wings and improvements for locks for displaceable wings that are transportable into other locks and locking devices without being limited to the complete locks described herein.

Throughout this specification and claims which follow, unless the context requires otherwise, the word “comprise”, or variations such as “comprises” or “comprising”, will be understood to imply the inclusion of a stated integer or group of integers but not the exclusion of any other integer or group of integers.

Throughout this specification and claims which follow, unless the context requires otherwise, the positional prepositions such as rear, forward are used to assist in description of the preferred embodiments and with reference to the accompanying drawings and have in general no absolute significance.

Throughout this specification and claims which follow, unless the context requires otherwise, the word “preferably” or variations such as “prefer” does not mean nor infer that that the inventions described in the “Description of the Preferred Embodiments” are necessarily restricted to the form of an integer or collection of integers referred to as preferred.

Throughout this specification and claims which follow, unless the context requires otherwise, the words “wing” embraces both doors and windows.

Throughout this specification and claims which follow, unless the context requires otherwise:

In isolated use, the engaging member is displaceable between a fully displaced disposition and a fully retracted disposition. When employed with an engageable means, the engaging member is displaceable between an operative disposition, a disposition in which the engaging member finds itself when engaged with the engageable means and an inoperative disposition removed from the said engagement. In many locks, the operative disposition corresponds with the fully displaced disposition but in some cases the engageable means acts to limit the displacement of the engaging member, and in many locks, the inoperative disposition corresponds to the retracted disposition. Within this specification, fully displaced will embrace substantially fully displaced as the operative disposition may be and retracted will embrace substantially fully retracted as the inoperative disposition may well be.

For example, in the case of a rectilinearly displaceable bolt for hinged doors, in the inoperative configuration the bolt is withdrawn from the strike plate aperture and in the operative configuration the bolt is within the aperture of a strike plate—the operative disposition generally corresponding to a fully displaced (fully extended) bolt while the inoperative disposition generally corresponds to a fully retracted bolt (substantially within the lock casing).

Latching means displacement of an engaging member into engagement with the engageable means under the action of biasing means.

In relation to hinged doors this includes: '1) displacement (rectilinearly and/or angularly) of a latch bolt towards the lock casing by the strike plate and subsequent displacement of the latch bolt by biasing means into the aperture of the strike plate or 2) displacement of an auxiliary bolt against biasing means (that may or may not be accompanied by displacement of a latch bolt) to render the auxiliary bolt unable to restrain the latch bolt whereby to enable the latch bolt to be displaced (rectilinearly and/or angularly) by biasing means into the aperture of the strike plate.

In relation to sliding wings this includes: '1) displacement (rectilinear and/or angular) of an engaging member having a hooking portion against biasing means and subsequent displacement of the engaging member to a disposition where the hooking portion lies behind a shoulder of a catch, or '2) displacement of an auxiliary bolt against biasing means (that may or may not be accompanied by displacement of an engaging member) to render the auxiliary bolt unable to restrain the latch bolt whereby to enable the latch bolt to be displaced (rectilinearly and/or angularly) by biasing means to a disposition where the hooking portion lies behind a shoulder of a catch, or '3) displacement of an auxiliary bolt against biasing means accompanied by rectilinear displacement of a latch bolt with hooking arms by a catch and subsequent displacement of the latch bolt by biasing means into the aperture of the catch and corresponding displacement of each hooking arm behind the peripheral edge of the catch aperture to longitudinally engage the catch.

A latch-bolt or latch bolt is an outwardly biased bolt capable of executing (or participating in) latching (and includes both rectilinearly displaceable and angularly displaceable bolts) and includes bolts having a leading end that is chamfered or otherwise profiled on one side to facilitate latching and includes advanced latch bolts (both pivotal and rectilinear) that are restrained in a pre-latching configuration prior to latching to either facilitate or assist latching and that in some forms are accompanied by an auxiliary bolt—advanced latch bolts in some forms comprising a prism shaped bolt that in some forms include counter-acting hooks and in some forms includes a leading end that is chamfered, curved or otherwise profiled on both sides to assist or facilitate latching.

An auxiliary bolt means an outwardly biased plunger that is operably associated with the advanced latch bolt

Unlatching means withdrawal of the bolt from engagement with the engageable means, and for hinged door it includes withdrawal of the bolt from the aperture of the strike plate.

An unlatching lever is a lever or knob that is hand operable to cause the latch bolt to become unlatched.

Locking means configuring the lock to restrain it from being unlatched and in some forms of locks employing deadlocking slides, it means restraining the deadlocking slide to restrain the bolt from being inwardly displaced by the unlatching lever.

Deadlocking means to configure the lock to restrain the bolt from being displaced from the fully displaced configuration (in the case of a rectilinearly displaceable bolt for a hinged door, it includes restraining the bolt in a fully extended position), the deadlocking means is some forms includes a deadlocking slide that is displaceable to cooperate with the bolt to restrain it against displacement and in some forms it includes displacement of a deadlocking slide to restrain an unlatching lever from being operated to un-deadlock a bolt; deadlocked means the bolt cannot be displaced from the fully displaced configuration by external forces,

Deadlatching means the bolt is automatically deadlocked during latching.

Remote lock means a locking means disposed from the lock that includes a remote engaging member that is operably connected to the lock (often there is an upper and a lower remote bolt situated above and below the lock)

French Door means a door comprising a frame with a glass in-fill and sometimes configured in pairs, a second door that is normally closed and is often secured by vertical bolts and a first door that supports the lock body and operable unlatching levers, often they have a strip of compressible sealing material located on the edge against which the first door closes to prevent energy loss, many French Doors comprise a hollow frame where the hollow within the frame is comparatively small in depth.

Security Doors means a door comprising a hollow framed door with an in-fill of mesh or woven stainless steel where the hollow within the frame is comparatively small in depth and in width

Lock body is the lock portion fitted within the hollow frame of the wing, the lock body together with a strike plate, a pair of handle sets and a cylinder comprising a typical mortice lock; depth of lock body is the extent of the lock body in a direction parallel to the face of the door; width of lock body is the extent of the lock body in a direction at right-angles to the face of the door

Single cylinder is a cylinder comprising a key operable barrel within a cylinder housing (in one form and commonly it comprises a barrel operably connected to a first cam having a radially protruding arm)

Double-cylinder comprises opposed barrels each operably connected to the same first cam; clutched-double-cylinder comprises a cylinder having opposed barrels each connectable without free movement to the same first cam such that the cam can be angularly displaced by a barrel while the other barrel remain undisplaced, the cylinder includes a clutch to select which barrel is the operative barrel, the clutch being operated after key insertion

Free rotation single cylinder is a cylinder comprising a key operable barrel within a cylinder housing operably connected with free movement to a first cam to enable the cam to be displaced by barrel to a locking configuration and then the barrel to be reverse rotated to an undisplaced position enabling key removal; free rotation-double-cylinder comprises opposed barrels each connected with free movement to the same first cam such that the cam is free (between limits) to be angularly displaced while the barrels remain undisplaced, this type of cylinder being commonly used in security door locks in Australia to enable the cam to be displaced by either barrel to a locking configuration and then the barrel to be reverse rotated to an undisplaced position enabling key removal while leaving the first cam in the locking position, (this type of cylinder being distinct from the double cylinders that employ clutches)

In some forms of both clutched and free rotation cylinders, one barrel is replaced by a hand operable turn knob; some single cylinder comprise a subassembly including a housing while in others, the housing comprises part of the handle backplate; some double cylinders comprise a subassembly including a housing while in others, the double cylinder housing comprises portions of the handle backplate.

A pivotal lock is defined herein as a lock having an angularly displaceable bolt herein called a pivotal bolt.

A rectilinear lock is defined herein as a lock having a rectilinearly displaceable bolt herein called a rectilinear bolt.

### DESCRIPTION OF THE FIGURES

Embodiments of the present invention will now be described by way of example only with reference to the accompanying drawings in which:

FIG. 1 is an isometric view of a wing supporting a lock,

FIG. 2 is a schematic side view of a lock body with the lid removed and placed beside the lock body, the bolt fully extended, the unlatching cam at the “undisplaced orientation” with the deadlocking slide upwardly displaced by the cylinder screw to be in the “undisplaced position”, the lock including, Bowden Cables

FIG. 3 is the lock of FIG. 3 with the deadlocking slide upwardly displaced to deadlock the bolt and to be in the “second locked configuration”,

FIG. 4 is the lock of FIG. 3 with the deadlocking slide further upwardly displaced to deadlock the bolt and to be in the “first locked configuration”, with a fully displaced driver annulus with displaced rigid drive members attached,

FIG. 5 is the lock of FIG. 1 (with unlatch rocker omitted for convenience only) with the deadlocking slide in the “undisplaced position” and the bolt in the “pre-latching configuration”,

FIG. 6 is the lock of FIG. 1 with the deadlocking slide in the “undisplaced position” and the bolt displaced to the retracted position by the unlatching cam,

FIG. 7 is the lock of FIG. 1 with the deadlocking slide in the “undisplaced position” and the bolt is in either of two different “pre-latching configuration”

FIG. 8 is an isometric view showing the lock body (with a casing side omitted) and the underside of the exterior handle assembly of an egress lock,

FIG. 9 is the lock of FIG. 1, adapted to include a deadlatching deadlocking slide and a deadlatching locking cam,

FIG. 10 is the lock of FIG. 1, adapted to include a modified deadlatching deadlocking slide to be key operable,

FIG. 11 is the lock of FIG. 1 adapted to be key operable to actuate remote locks,

FIG. 12 is the lock of FIG. 11 without a bolt or unlatching levers and including a locking plunger to comprise a lock for a second French Door,

FIG. 13 is an isometric view of a drive bolt and strike plate,

FIG. 14 is an isometric view of a chamfered bolt,

FIG. 15 is an isometric view of a chamfered prism like bolt,

FIG. 16 is a plan view of an extended prism like bolt with hooking arms,

FIG. 17 is a schematic side view of the lock body of a pivotal bolt lock (with some components common to the rectilinear lock omitted for convenience) in pre-latching configuration,

FIG. 18 is a schematic side view of the lock body of a pivotal bolt lock (with some components common to the rectilinear lock omitted for convenience) in deadlocked configuration,

FIG. 19 is an exploded isometric view of the lock of FIG. 8,

FIG. 20 is an isometric view of the single shaft and single unlatching cam

FIG. 21 is an exploded isometric view of the lock of FIG. 18.

Throughout this specification and claims which follow, unless the context requires otherwise, the word “locks” or variations such as “lock” will be understood to imply the inclusion of complete locks for displaceable wings and improvements for locks for displaceable wings that are transportable into other locks and locking devices without being limited to the inclusion in the complete locks described herein.

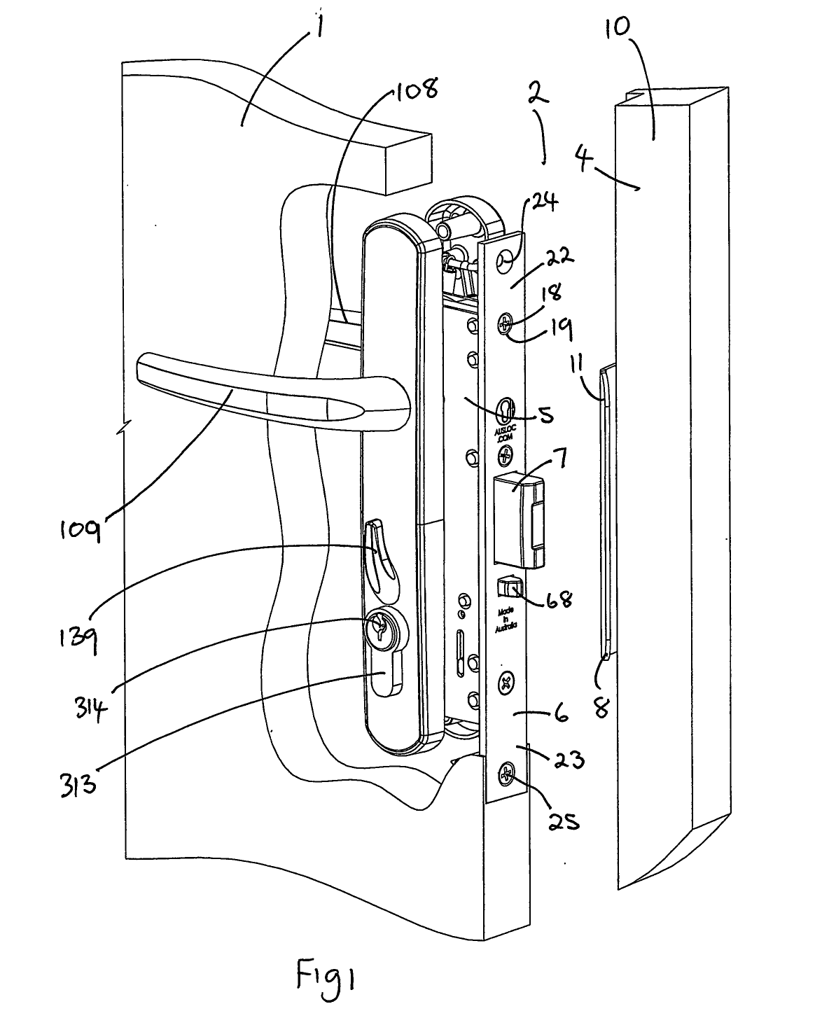

The inventions described herein relate to pivotal and rectilinear locks for displaceable wings 1 supported adjacent an opening 2 as shown in FIG. 1, where the wing has a closing edge 3 that in the closed position of the wing, is adjacent an element 4 that helps define the extent of the opening and the lock is mounted relative to this closing edge.

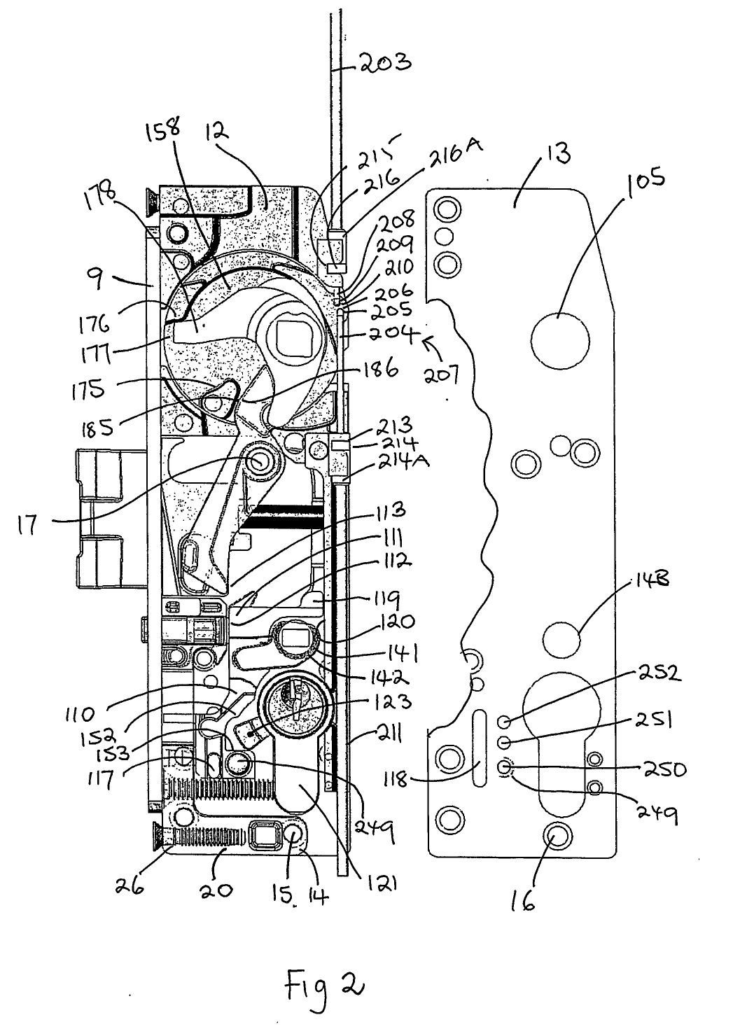

In some forms, the invention includes a lock body 5 that is mounted within the door that includes a substantially rectangular lamina-like front plate 6 and an engaging member 7 that is displaceable to engage with an engageable means 8 mounted relative to the element. In some forms, the invention includes an alternative reduced front plate 9 of reduced length as shown in FIG. 2.

Where the wing comprises a conventional hinged door, the element comprises a conventional door-jamb 10 and the engageable means comprises a strike plate 11. Where the wing comprises a conventional sliding door (not shown), the engageable means comprises a catch plate.

Locks described herein include; locks that are lockable by the cylinder and/or interior locking lever; deadlatching locks that automatically deadlock on latching; and locks where the exterior unlatching lever is unlockable by operation of the interior unlatching lever. These locks employ many common components and therefore can be said to comprise as a lock series.

The lock body also includes a casing 12 having substantially rectangular lamina-like sides 13 attached to internal fixed portions 14 by substantially cylindrical rivets 15 that have passage through apertures 16 in the casing sides. Some of these rivets comprise an extension of a fixed portion (that preferably comprises a casting) that extend through an aperture of the side to protrude from the external side where it is peened over to prevent its withdrawal, and alternatively the rivet comprises a separate metal rivet 17 that extends through both sides of the casing to be peened over on the external faces of the sides.

The front plate 6 is preferably attached to the casing by screws 18 that extend through screw apertures 19 in the front plate to engage in screw recesses 20 in the fixed portions, as shown in FIG. 2. A reduced front plate is similarly attached to the casing 12 by alternative screws 21 shown in FIG. 8, that extend through screw apertures in the front plate to engage in different screw recesses in the fixed portions. The front plate includes an upper fixing tab 22 and lower fixing tab 23 each having a screw aperture 24 through which a fixing screw 25 extends to engage in a recess in the closing edge of the wing as shown in FIG. 1.

When the lock is fitted differently within a hollow frame wing and so as to employ the reduced front plate, as shown in FIG. 2, screw recesses 26 in the edge of the lock casing are left exposed to accept fasteners that extend through corresponding apertures in the frame portion (that defines the closing edge 3 of the wing) to engage in the screw apertures 26 (which are adjacent the internal face of the hollow frame). In this case, the reduced front plate fills the gap within the closing edge through which the lock is inserted to be fitted—this gap being of a height less than the height of the casing so that the upper and lower ends of the casing extend to overlap the frame portion that defines the closing edge 3 of the wing.

In some locks (not shown), a substantially rectangular spacer is between the front plate and casing to separate them to provide a lock of increased back-set distance and in which case the bolt and auxiliary bolt are of extended length.

In other forms (not shown), the front plate, the internal fixed portions and casing (except for one side) comprise a single.

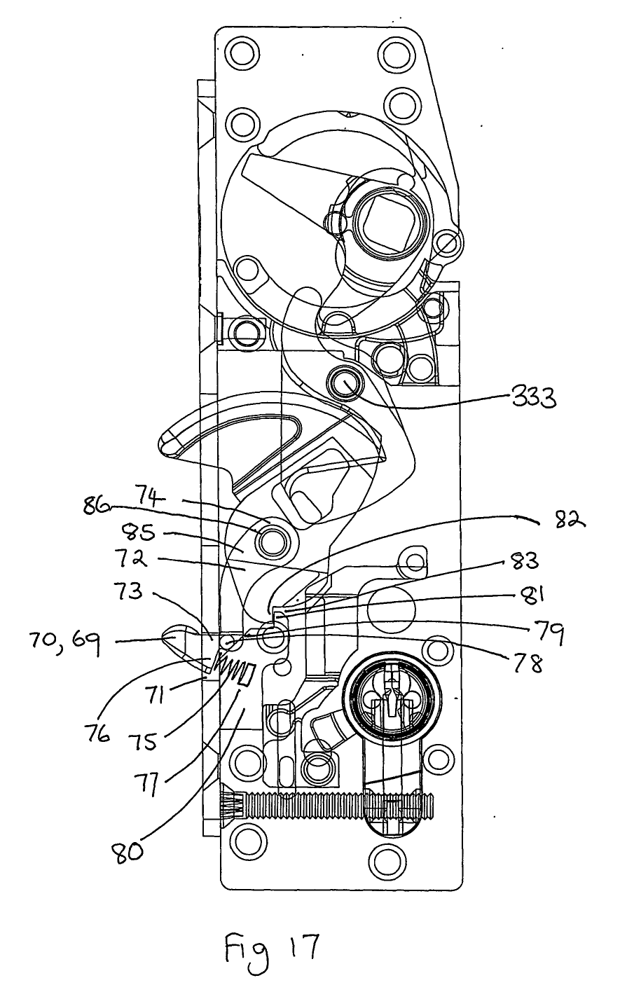

Unless otherwise stated, all complete locks include an engaging member that in one form comprises a rectilinear bolt 27 (as the engaging member) as shown in FIG. 15, the bolt is located below the unlatching cam/s described below; the rectilinear bolt 27 comprising a first bolt portion 28 that has passage through a rectangular bolt aperture 29 in the front plate and a return bolt portion 30 within the casing; the bolt aperture having a form corresponding to the cross-section of the bolt and providing working clearance between the bolt and bolt aperture 29. With reference to FIG. 5, the rectilinear bolt includes a longitudinally elongated support recess 31 having an opening 32 on the inside end of the bolt. Supported by the rear casing wall 33, is a T member 34 comprising a vertical plate 35 that is supported in a slotted aperture 36 of the rear wall 33 and an orthogonal forward projecting guide pin 37 (that is preferably cylindrical) extends into the support recess to comprise a telescopic joint so that the guide pin is able to support the bolt over its working range of dispositions—the bolt also being supported by the peripheral edges of the front plate bolt aperture 29 and the sides of the casing.

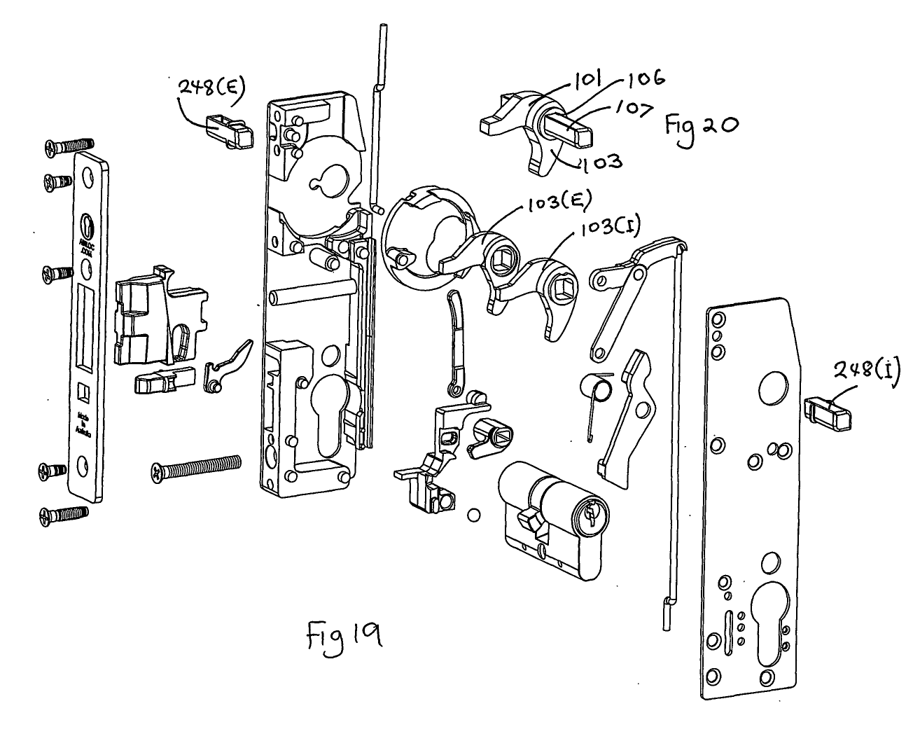

In another form the engaging member comprises a pivotal bolt 38 (as the engaging member) as shown in FIG. 18 located below the unlatching cam/s described below, comprising an angularly displaceable member that is displaceable about a bolt shaft 39 that preferably comprises a separate metal rivet as described above that extends through a bolt aperture 40 in the pivotal bolt to support the bolt. The pivotal bolt 38 includes a first pivotal bolt portion 41 that in some forms is displaceable so that a portion of it protrudes from the casing and return pivotal bolt portion 42 angularly disposed from the first pivotal bolt portion relative to the pivotal axis of the pivotal bolt. The pivotal bolt comprises in one form, a segment of a substantially solid parallel-sided cylindrical disc defined in part by an outer radius R referenced from the bolt pivotal axis and having a general thickness T and bounded by two spaced edges including a leading edge 43. Within at least one side of the bolt, between the pivotal axis and outer edge, extending from the leading edge is a side recess 44 defined by an outer recess radius r that does not extend to the outer edge and so leaving a sideways relatively protruding shoulder (“relatively” meaning that the shoulder may be within the general thickness but in relation to the adjacent side recess it comprises a sideways protruding shoulder) comprising an arcular shoulder 45. Accordingly, the side recess 44 is planar at a relative depth of t and defined by a normal vector that is parallel to the pivotal axis of the bolt and the relatively protruding shoulder has a radial width of R-r and a relative height of t and the thickness of the bolt through the recess (or through the recesses) (herein called the web thickness) is equal to T-t. When each side of the bolt is profiled as described above, the width of the bolt between side recesses is T-2t.

Although preferable that the outer edge of the bolt have a constant radius R, and the side recess be defined by a constant radius these configurations are not essential to the pivotal bolt. However, this form provides the advantage that the strike plate, once aligned to enable the bolt to enter the entry aperture (defined below) will provide free passage to the bolt over its full range of displacement. Even if the bolt is displaced relative to the strike plate when in the fully extended position, it can be displaced to withdraw from the strike plate aperture without having to deform the strike plate. If the bolt is urged against the strike plate it can be displaced (by overcoming frictional forces) to withdraw from the strike plate aperture and again without having to deform the strike plate.

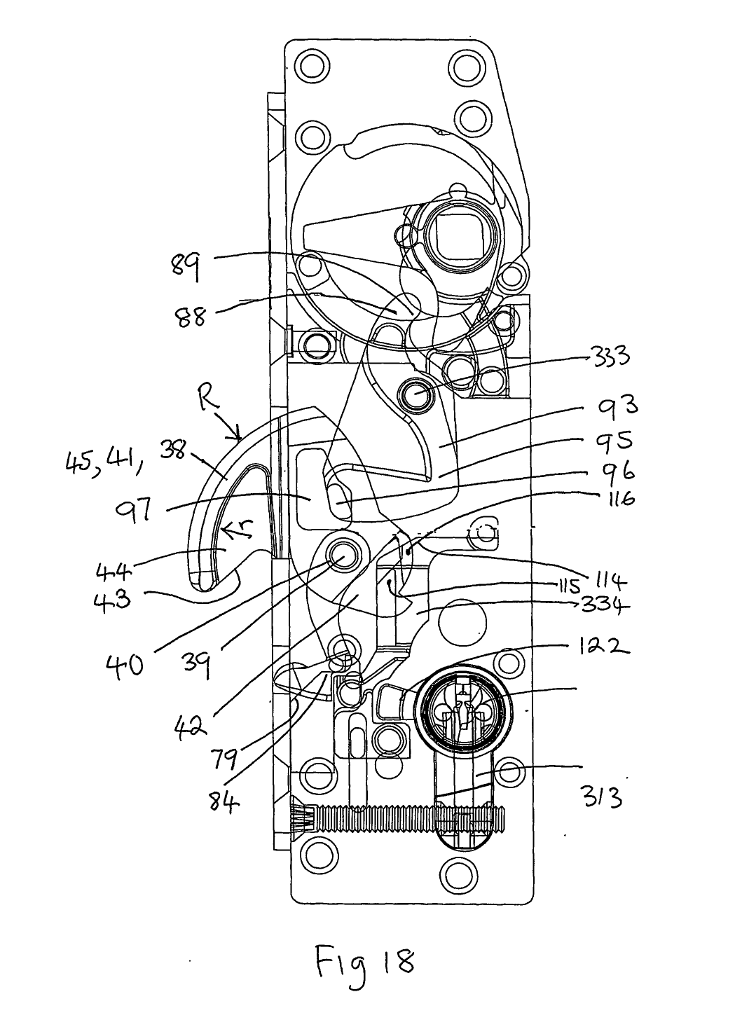

The various complete locks described below comprised of the integers described herein may be configured as either pivotal locks or rectilinear locks having any one of the bolts described herein (unless otherwise stated). The rectilinear bolt may electively comprise a bolt described within the definitions or elsewhere including an advanced latch bolts, as shown in FIG. 5 and 17, characterized by a pre-latching configuration in which the latch bolt is disposed from the fully displaced configuration and that during latching is enabled to be displaced to the fully displaced configuration, and the deadlatching locks described herein must include an advanced latch bolts. An advanced latch bolt as defined herein, is accompanied by an outwardly biased displaceable auxiliary bolt that when extended acts to restrain the latch bolt from being displaced from the pre-latching configuration towards the fully displaced configuration.

In some advanced latch bolts for sliding doors, the pivotal bolt first portion is always substantially within the casing and the fully displaced configuration comprises the engageable means protruding into the casing to be engaged with the pivotal bolt.

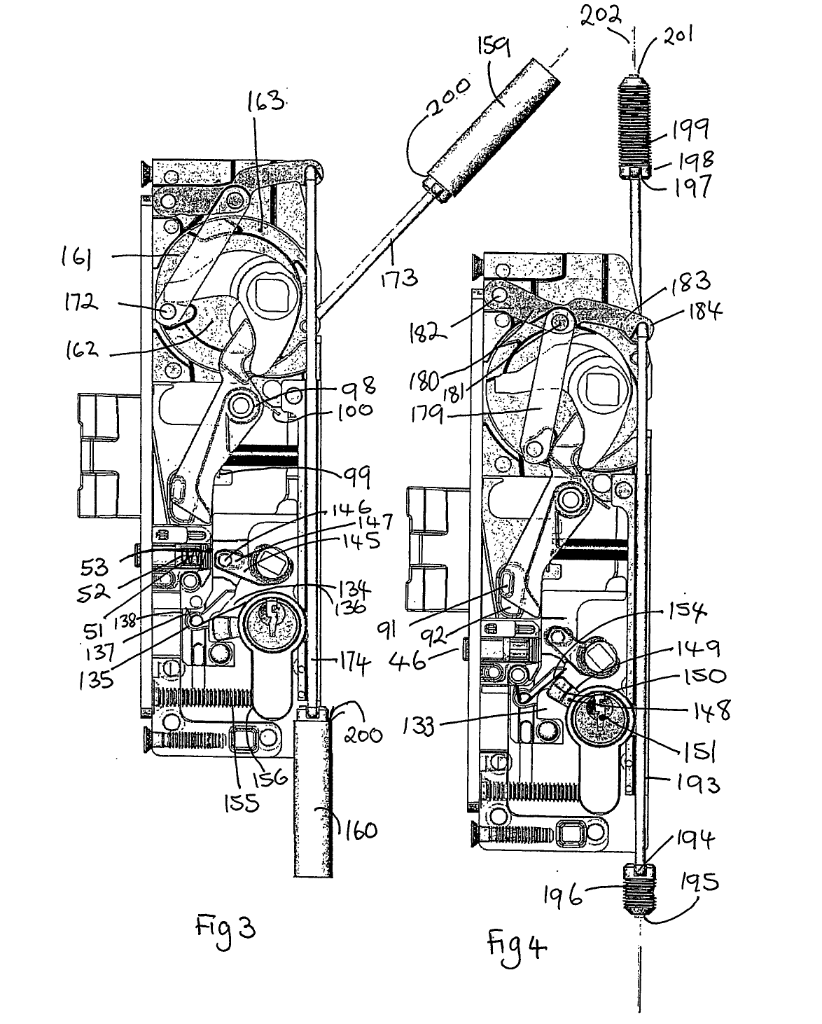

In embodiments including an advanced rectilinearly displaceable latch bolt, as shown in FIG. 5 and 7, there is an auxiliary bolt 46 (preferably located on the opposite side of the latch bolt to the unlatching cam described below) comprising a first auxiliary bolt portion 47 that has passage through an auxiliary bolt aperture 48 in the front plate and return auxiliary bolt portion 49 that is within the casing and by which it is supported. Some return auxiliary bolt portions have a blade-like rearwardly extending portion 50 for better support. The auxiliary bolt is outwardly biased by a compression spring 51 shown in FIG. 3, that acts between the outer end of an open-sided spring recess 52 within the return auxiliary bolt portion and a vertical wall 53 of a casing fixed portion.

The return auxiliary bolt portion, as shown in FIG. 7, has a sideways protruding side pin 54 that engages with a profiled side recess 55 of an adjacently positioned and substantially lamina control rocker 56 that is located within the casing between a side wall of the casing and the return auxiliary bolt portion. The control rocker being supported by a rocker pivotal joint 57 located beneath the advanced latch bolt and auxiliary bolt and adjacent to the front plate and forward of the side pin 54—the rocker pivotal joint 57 defining a pivotal axis orthogonal to a side of the casing. The control rocker extends vertically and rearwardly from its pivotal axis to terminate in a free end portion 58 that has a control shoulder 59 that is engageable with the latch bolt (to restrain the bolt) when the latch bolt is in the pre-latching configuration. The control rocker profiled side recess includes an inwardly and upwardly ramped edge 60 that lies in the same vertical plane as the side pin 54. The parts are configured such that as the auxiliary bolt is inwardly displaced, the side pin 54 slides along the ramped edge 60 of the control rocker to cause the control rocker to displace away from the latch bolt to cause the control shoulder 59 to be displaced away from a bolt edge recess 61 of the rectilinear advanced latch bolt to a position where it cannot be engaged by the latch bolt—the bolt edge recess 61 comprising a recess in the under-edge of the bolt. In some bolts it comprises a slot 62 extending outwardly from an angled slot end 63. In some locks when the lock is in the pre-latching configuration, the surface of the slot end 63 contacted by the control shoulder 59 is defined by a vector normal to the surface of the slot end that intersects the control rocker pivotal axis—this geometry being characterised by the control shoulder 59 being able to slide on the surface of the slot end 63 without causing the latch bolt to displace and, an outwards force on the latch bolt not giving rise to a moment on the control rocker.

The profiled side recess of the control rocker 56 also includes a substantially vertical forward shoulder 64 that lies in the same vertical plane as the side pin 54 and in front of the side pin 54 and that extends upwardly from the rocker pivotal joint 57. The parts are configured such that during outwards displacement (from the retracted position) of the auxiliary bolt, the side pin 54 engages the inside edge of the forward shoulder 64 to pivot the control rocker outwardly to cause the control shoulder to displace upwardly towards the bolt towards engagement with the rectilinear advanced latch bolt. Within the side recess of some control rockers, as shown in FIG. 7, there is a substantially elongation 65 that is horizontal when the latch bolt is disengaged from the control rocker to enable the auxiliary bolt to be inwardly displaced without substantially displacing the control rocker.

As shown in FIG. 7, the front plate can be removed to enable the control rocker to be removed from the casing to be replaced by another whereby to change the distance the auxiliary bolt and/or latch bolt protrude from the front plate in the pre-latching configuration. In locks having this adaptability, the pivotal joint comprises a horizontal rocker pin 66 that is supported within a U shaped pocket 67 of a fixed casing portion with the opening to the pocket abutting the front plate so that removal of the front plate provides accessibility to the pocket. This means for changing the distance the bolt protrudes in the pre-latching configuration comprising one of the many inventions described herein.

In normal usage, the latch bolt is displaced to the retracted position by operation of an unlatching lever 108 or 109 (described below) and as shown in FIG. 6, to enable the wing to be opened and as this occurs, the auxiliary bolt 46 outwardly displaces to a position where the side pin 54 is restrained by the forward shoulder 64 of the control rocker 56 itself restrained by the control shoulder 59 abutting the underside of the latch bolt. As the unlatching lever is subsequently allowed to reverse towards the undisplaced position, the latch bolt outwardly displaces till the bolt edge recess 61 presents itself to the control shoulders 59 which then enters the bolt edge recess to restrain the latch bolt in the pre-latching configuration.

The auxiliary bolt described above and the pivotal auxiliary bolt described below, each preferably have first portions that include a leading end 68 similarly profiled (curved, chamfer or otherwise profiled) on both sides, as shown in FIG. 1, to accommodate both left hand and right hand doors to facilitate latching wherein the pivotal auxiliary bolt is engageable on either side by a strike plate to be inwardly displaced by the strike plate during latching.

In embodiments including an advanced angularly displaceable latch bolt, as shown in FIG. 17, there is a pivotal auxiliary bolt 69 (preferably located on the opposite side of the latch bolt to the unlatching cam described below) comprising a first pivotal auxiliary bolt portion 70 that has passage through an auxiliary bolt aperture 71 in the front plate, and a return pivotal auxiliary bolt portion 72 within the casing by which it is supported and comprising shoulder portion 73 connected to a flat arm 85 that extends along the inside of a side wall of the casing to terminate in a flat washer-like washer portion 74 having an aperture 86 though which the bolt shaft 39 extends to provide a pivotal axis for the pivotal auxiliary bolt and it is outwardly biased by the compression spring 75 supported between the shoulder portion 76 and a vertical wall 77 of a casing fixed portion. The pivotal auxiliary bolt has a sideways protruding side pin 78 (similar to 54 and preferably both 54 and 78 are cylindrical in form) that extends outwardly from the shoulder portion 73 to abut the angled side edge 79 of a displaceable control slide 80 that extends vertically along a side wall between the shoulder portion 73 and the adjacent side wall. The control slide has a substantially vertically disposed control shoulder 81 that in the pre-latching configuration, is within a rearwardly opening edge recess 83 of the return portion of the pivotal bolt defined in part by a forward engaging shoulder 82. The parts are configured such that as the auxiliary bolt is inwardly displaced the side pin 78 slides along the upwardly and inwardly angled side edge 79 to displace the control slide 80 away from the bolt to displace the control shoulder 81 from the edge recess 83. In some forms of locks the angled side edge 79 is connected to a substantially horizontally elongated portion 84 to enable the auxiliary bolt to be inwardly displaced without substantially displacing the control rocker to accommodate additional displacement of the pivotal auxiliary bolt.

In normal usage the pivotal latch bolt is displaced to the retracted position by operation of an unlatching lever (described below), subsequently the wing is opened and as this occurs the pivotal auxiliary bolt displaces outwardly to a fully extended position leaving the control slide abutting the underside of the return portion of the pivotal latch bolt (which has a continuous curved profile), and as the unlatching lever is then allowed to reverse towards the undisplaced position, the latch bolt outwardly displaces till the bolt edge recess 83 presents itself to the control shoulder 81 which then enters the bolt edge recess 83 to abut the engaging shoulder 82 to restrain the return portion of the pivotal latch bolt from displacing inwardly from its pre-latching configuration whereby to restrain the first pivotal bolt portion from displacing outwardly.

All complete locks (unless otherwise stated) include an unlatching rocker, that in one form comprises the unlatching rocker 87 (for rectilinear locks) that is angularly displaceable about a pivotal joint having a pivotal axis that is orthogonal to the sides of the casing and located between the latch bolt the unlatching cam/s described below and disposed substantially midway between the front and rear sides of the casing as shown in FIG. 2. The pivotal joint comprises a rocker shaft 333 that passes through an aperture in the unlatching rocker, the rocker shaft comprising a pinned extension of the casing or alternatively a metal rivet that passes through both sides of the casing to both support the rocker relative to the sides and help retain the casing sides. The unlatching rocker 87 has a first rocker arm 88 extending upwardly from the pivotal joint to terminate in an engageable shoulder 89 and a second rocker arm 90 extending downwardly to overlap the return bolt portion to enable a sideways protruding drive pin 91 of the second arm to locate in a bolt drive recess 92 in a side of the rectilinear latch bolt.

In another form, the unlatching rocker comprises a pivotal unlatching rocker 93 having a first unlatching rocker arm 94 similar to that described above and a modified second unlatching rocker arm 95 that extends downwardly to overlap the first bolt portion to facilitate operable coupling through a sideways protruding drive pin 96 of the second arm that locates in a pivotal bolt drive recess 97 in a side of the bolt so that the latch bolt is angular displaceable towards the retracted position by inwards displacement of the drive pin 96—this pivotal unlatching rocker functioning as that described above.

As shown in FIG. 3 and other figures, the pivotal and rectilinear locks within this invention that have latch bolts include means to outwardly bias their respective latch bolts comprising a bolt torsion spring 98 supported around the unlatching rocker shaft 333 that has a free end 99 that acts on the second arm of the unlatching rocker to outwardly bias it and a fixed end 100 restrained by the casing and the substantially cylindrical body of the torsion spring is supported about the shaft. Alternatively, some locks include a compression between the bolt and rear casing wall that acts directly on the bolt but to minimize the components types within the lock series it is preferable that all locks employ the torsion spring that acts on the unlatching rocker.

Unless otherwise stated, all complete locks include an operating means operable to displace the engaging member towards the fully retracted disposition comprising an unlatching cam 101, as shown in FIG. 6, that is connected to a hand operable unlatching lever such as unlatching lever 109 shown in FIG. 1 and other figures. The unlatching cam has a downwardly extending unlatching arm 102 that (towards its free end) has a driving shoulder 103 that is rearward of the rocker first arm and within the same plane such that that forward displacement of the driving shoulder (by downwards unlatching lever displacement) causes the first rocker arm to displace in a forward direction to cause the second rocker arm to rearwardly displace to cause the bolt to displace towards the retracted position. As shown in FIG. 2, each unlatching cam is supported by at least one sideways protruding cylindrical portion 104 that extends into a circular aperture 105 in a side of the casing. This cylindrical portion also includes a portion of the unlatching cam drive aperture 106 that mates with a drive shaft 107.

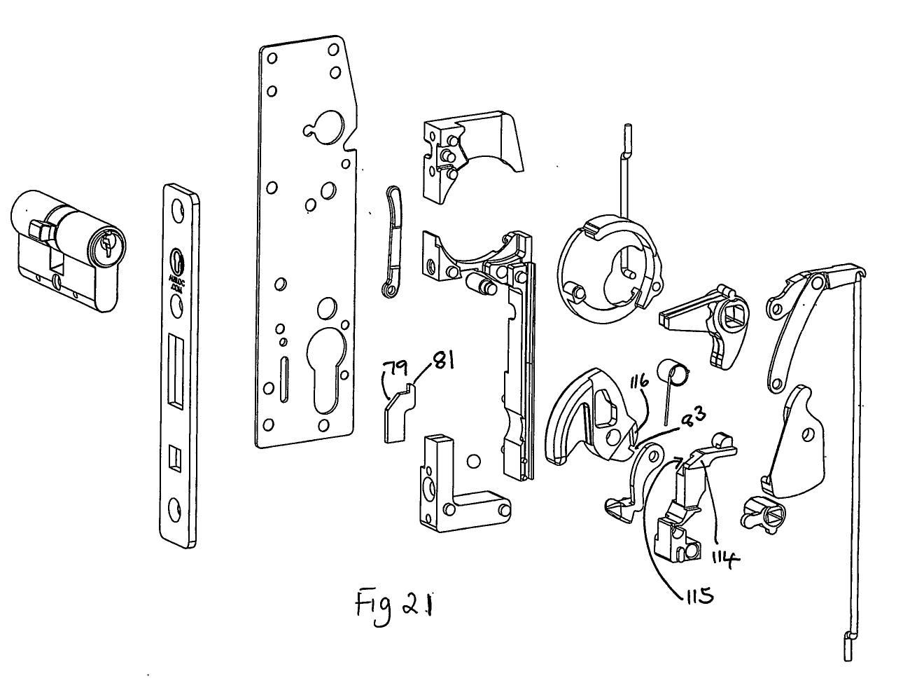

Unless otherwise stated, all complete locks include an unlatching cam 101, an exterior unlatching lever 108 and an interior unlatching lever 109 all connected by a shaft 107 that has passage through (while meshing with) the drive aperture 106 in the unlatching cam, as shown in FIG. 20) this shaft also mating within a drive recesses 248 in each unlatching lever.

Unless otherwise stated, all complete locks include a deadlocking slide that in one form comprises as a rectilinear deadlocking slide 110 (and where the context requires, deadlocking slide means rectilinear deadlocking slide 110) located on the opposite side of the latch bolt to the unlatching cam described below, as shown in FIG. 2 and other figures, that is displaceable to and from a deadlocking configuration. The location of the deadlocking slide on the opposite side of the latch bolt to the unlatching rocker pivotal axis facilitating functional interaction between the lower end of the unlatching rocker and the leading end 111 of the deadlocking slide.

The deadlocking configuration is characterised by the bolt and deadlocking slide cooperating to restrain the bolt from being displaced to the retracted position. When participating in the deadlocking configuration, the deadlocking slide can be said to be in a deadlocking position. In the deadlocking slides of the various rectilinear locks, an engaging shoulder 112 of a leading end 111 of the deadlocking slide is engageable behind an engageable shoulder 113 of the rectilinear latch bolt to restrain it against inwards displacement—the engaging shoulder 112 being in the same vertical plane as the engageable shoulder 113, a plane that is parallel a casing side. [Within the scope of this invention the deadlocking position comprises a limited range of deadlocking slide positions over which the bolt and deadlocking slide so cooperate and the invention embraces the bolt being within a limited range of fully displaced positions over which the bolt and deadlocking slide cooperate and from which the bolt is restrained against displacing].

In other forms, the deadlocking slide comprises a pivotal deadlocking slides 334, as shown in FIGS. 18 located on the opposite side of the latch bolt to the unlatching cam described below, having a leading shoulder 115 at the leading end 114 of the pivotal deadlocking slides 334 that is displaceable to a position in front of a return shoulder 116 of the pivotal bolt return portion to restrain that portion from outwardly displacing whereby to restrain the first bolt portion from inwardly displacing. The leading end portion 114 is defined in-part by a change in the width of the bolt, the shoulders laying in the same vertical plane parallel to a casing side. [The invention embraces the pivotal bolt being within a limited range of angular positions over which the bolt and deadlocking slide so cooperate and from which the pivotal bolt is restrained against displacing].

As shown in FIG. 2 and other figures, all deadlocking slides 110 and 334 are supported by a sideways protruding guide pin 117 that is within a vertically elongated guide slot 118 of a casing side and in some locks it is alternatively or as well as, supported by a rearwardly extending deadlocking slide foot 119 that abuts the inside face 120 of the casing rear wall and in operation to slide along the inside face of this wall.

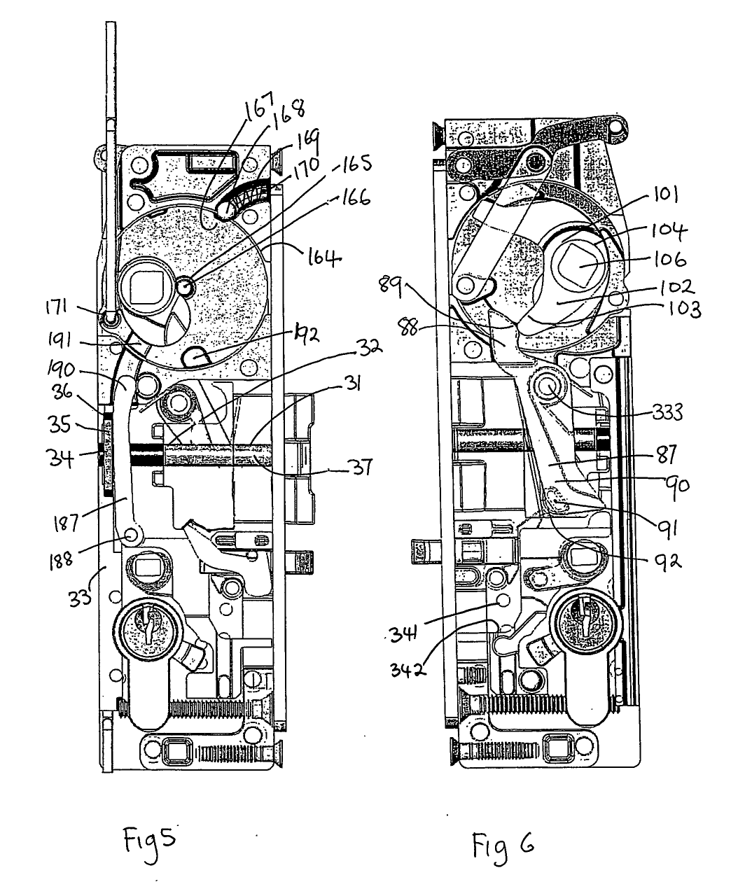

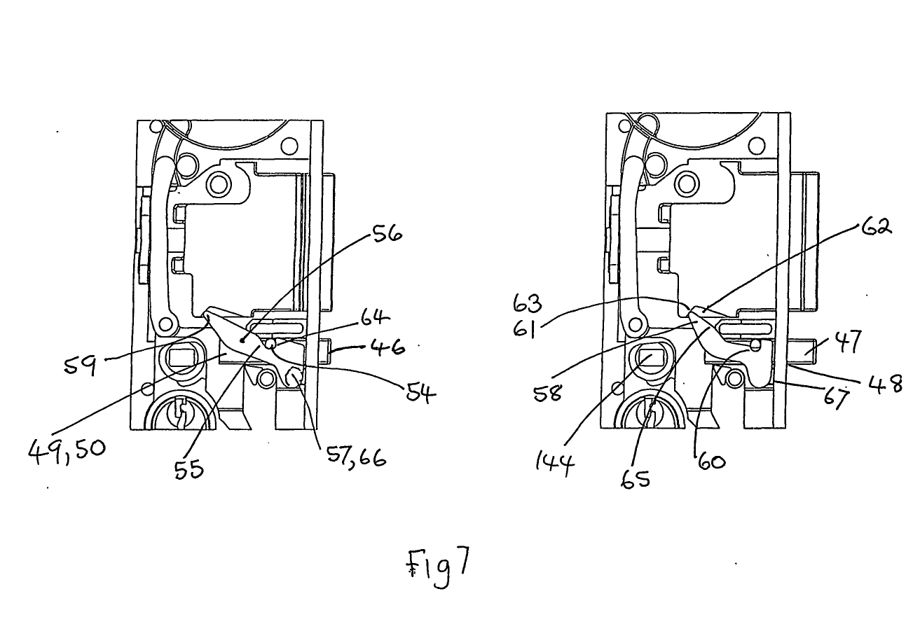

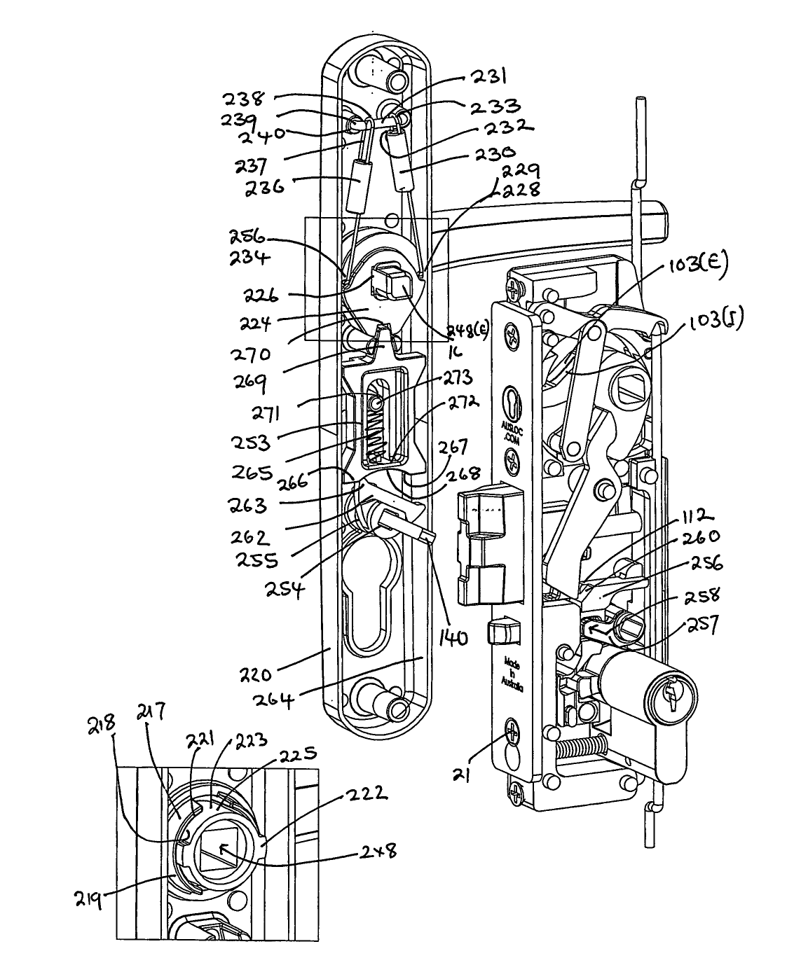

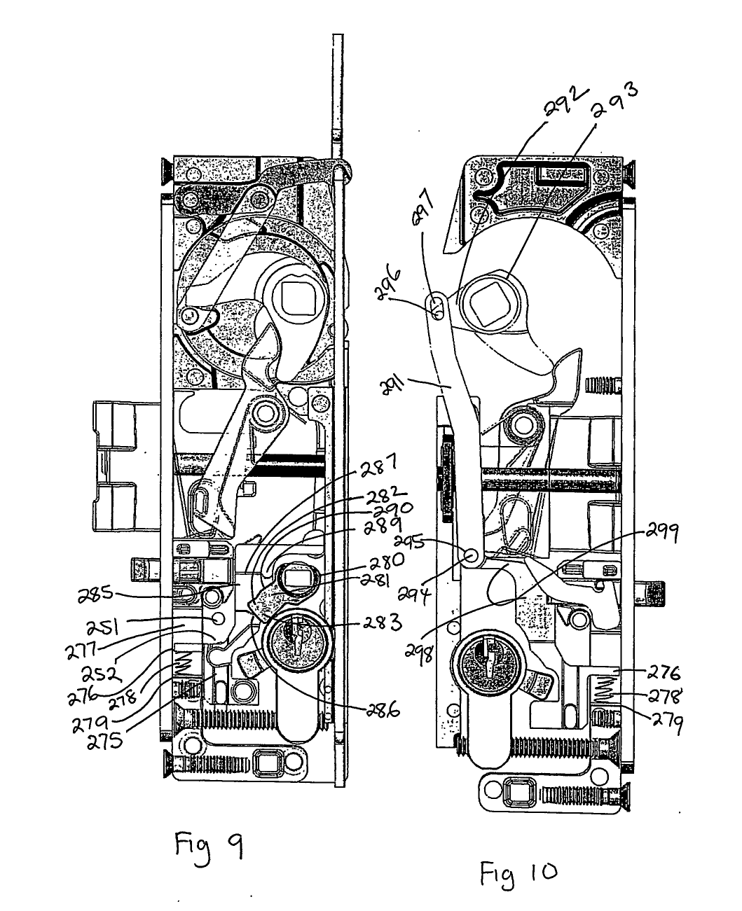

Unless otherwise stated, all complete locks include means to communicate displacement to the deadlocking slide (if included) to enable it to be displaced. In some embodiments, the means includes a first cam 148 having a first cam arm 149. Where the means comprises a substantially conventional separate double cylinder 121 assembly shown in the figures, the first cam 148 comprises a cylinder cam 122 and the first cam arm 149 comprises a cylinder cam arm 123 and the deadlocking slide 110 includes a drive recess 133 (FIG. 4) to accept and mesh with the cylinder cam arm 123 or first cam 149.

All complete locks having a cylinder, unless otherwise stated, employ a deadlocking slide 110 having a torsion slide spring 134 to bias the first cam arm against leaving the drive recess. The slide spring 134 is supported in a cylindrical recess 135 in a side of the deadlocking slide recess below the drive recess as shown in FIG. 3 and other figures. The spring has a spring arm 136 that extends rearwardly to intersect the locus of movement of the end of the first cam arm 132 and a fixed end 137 is restrained within a slotted aperture 138 of the deadlocking slide. The spring arm preferably lies in the same plane as a central plain of the lock body and first cam, parallel to the plane of a casing side and midway between the two sides. Parts are configured such that the first cam arm 149 cannot leave the drive recess during normal operation without displacing the slide spring arm 136 and when the lock is in a first locked configuration, the first cam arm 149 and slide spring arm 136 are substantially orthogonally disposed as shown in FIG. 4 in which configuration, the vector defining the point on the surface of the first cam arm in contact with the spring arm, passes substantially through the pivotal axis of the first cam.

This means of providing a first and second locked configurations by employing a slide spring comprises one of the many inventions that are applicable to other locks and not just the complete locks described herein.

In some locks, the deadlocking slide has an adapted leading end that includes a ramped or otherwise profiled shoulder that extends inwardly while extending upwardly—this being configured such that as the deadlocking slide is displaced towards the deadlocking position, the ramp engages with the lower rear corner of the engageable shoulder 112 of the bolt to urge and displace the bolt outwardly—the action taking place by dint of the ramp sliding over the corner to exert a force having an outwards component. In these locks the deadlocking configuration corresponds to a fully extended bolt.

All complete locks, unless otherwise stated, electively include a hand operable locking member to displace the deadlocking slide that may comprises an interior rectilinearly displaceable hand operable member (not shown) supported relative to the interior handle assembly that has passage through an aperture in a side of the wing to be connected to the deadlocking slide. Preferably, the locking member comprises a hand operable angularly displaceable locking lever 139 (otherwise called a snib lever) as shown [symbol] by a spindle 140 shown in FIG. 8, (that has passage through an aperture in a side of the wing) to an angularly displaceable locking cam 141 within the casing as shown in FIG. 3.

The locking cam is supported by cylindrical portions 142 that extend into circular apertures 143 in the sides of the casing, as shown in FIG. 2 and has a spindle aperture 144 (FIG. 7) to accept and mate with the spindle. The locking cam further includes a locking cam arm 145 having a displaceable free end portion that overlaps a portion of the deadlocking slide to couple the deadlocking slide and locking cam. In some forms, the free end portion has a sideways protruding pin 146 within a substantially horizontal slot 147 within the deadlocking slide to couple the deadlocking slide in a slide follower relationship.

Some pivotal and rectilinear locks, as shown in FIG. 4, include an angularly displaceable first cam 148 to displace the deadlocking slide to and from the deadlocking configuration. The first cam in some forms is independently supported in the casing. The first cam arm has a radially protruding first cam arm 149 defined in part by an end face 150 that comprises an arcular portion of constant radius and a first cam pivotal axis 151. As shown in FIG. 2, the first cam arm can acts on a substantially horizontal upper drive face 152 of the drive recess 133 of the deadlocking slide to displace the deadlocking slide towards the deadlocking and acts on a substantially horizontal lower drive face 153 to displace the deadlocking slide from the deadlocking configuration. To provide a first locked configuration, the drive recess 133 includes an exit shoulder 154 that in one forms comprises an angled face connected to the upper drive face 152 disposed such that when the lock is in the first locked configuration shown in FIG. 4, the first cam end face 150 abuts the exit shoulder so that the force applied to the first cam by the deadlocking slide when an attempt is made to move the deadlocking slide from the deadlocking configuration (as might occur in an attempt to rotate the snib lever), has a direction that passes through the pivotal axis 151 of the first cam without giving rise to a moment to cause the first cam to rotate; and additionally, the first cam in this configuration restrains the deadlocking slide from displacing from the deadlocking configuration. The lock can only be configured to and from the first locked mode by actuation of the first cam.

Locks can also be configured into and out of a second locked mode or configuration shown in FIG. 3, characterized by the first cam arm 149 being within the drive recess 133 and the deadlocking slide being in a deadlocking configuration. The lock is configurable to the second locked configuration by actuation of the interior locking lever and by actuation of the first cam.

Where a cylinder screw 155, as shown in FIG. 3 is employed to restrain a separate lock cylinder (also called a double cylinder, or just cylinder) relative to the casing, the screw has passage through the casing to be engaged in a threaded aperture 156 in the cylinder, and in these forms the screw also preferably performs the function of restraining the first cam arm against leaving the drive recess by displacing in a direction away from the bolt; the screw does this by restricting the downward displacement of the deadlocking slide from what is defined herein as the “undisplaced” position of FIG. 2 where the first cam arm 149 is captured within the drive recess 133. During fitting, after the cylinder has been inserted in the cylinder aperture in the lock body, the first cam arm 149 is rotated to be within the drive recess 133 at which time the cylinder screw is inserted to displace the deadlocking slide away from the initial position and to the undisplaced position.

In some pivotal and rectilinear locks, (not shown) the first cam is supported in apertures within the side walls of the casing to be operably connected on one side to a key operable cylinder having an angularly displaceable barrel, the cylinder having a housing supported in or comprising a portion of the back-plate of a handle assembly. In some lock, there is a pair of opposed cylinders as described above. In each case the barrel has an inwardly projecting extension that engages in a side recess of the first cam with free movement. In some locks the barrel comprises a wafer supporting barrel and each barrel has a peripheral end side protrusion in line with the wafers and similar in form to an extended wafer. The housing has the normal longitudinally elongated cylindrical aperture bounded by opposed parallel longitudinally elongated wafer apertures that are preferably rectangular in form that open into the cylindrical aperture, the wafer recesses to facilitate wafers protruding from the barrel as is well known; however in the locks within one wafer aperture has an end wall and the other has an aperture to permit passage of the end side protrusion so that the barrel can be inserted and rotated to be unable to be removed. Preferably, the barrels and cylinder cam are coaxially supported and the portion of the barrel protruding from the cylindrical aperture includes an end extension to engage in a side recess in the first cam to operate the cam. Once assembled the barrel movement is restricted by its engagement with the first cam to dispositions where the protrusion does not become aligned with the aperture enabling barrel removal.

The inventions herein include means to operate at least one remote engaging member; this invention being applicable to the pivotal and rectilinear locks described herein. This means include a drive member 158, as shown in FIG. 2 and other figures, to operate at least one remote engaging member, the drive member being supported within the casing to be operably connected to each unlatching lever so that upwards displacement of an unlatching lever causes the driver member to displace to actuate each remote engaging member to a fully displaced position where the remote engaging member comprises a bolt, this comprises an extended position where it protrudes from the wing. In some locks, upwards displacement causes the bolt to be driven to the fully displaced position (if in the case of latch bolts, it has not been displaced there by the biasing means). Downwards unlatching lever displacement causes the driver member to actuate each remote engaging member from the fully displaced position while causing the bolt to retract.

In some locks there is an upper engaging member (not shown) operably connected to the driver member by an elongated upper drive member 159 and a lower engaging member (not shown) operably connected to the driver member by a elongated lower drive member 160 as shown in FIG. 3. The driver member in some locks is connected directly to one or both elongated drive members and in other locks the driver member is operably connected to one or both drive members by one or a pair of interspaced drive slides supported within the casing. In some locks there is a pair of counteracting drive slides (an upper and a lower) that are supported within the lock casing and which are connected to the driver member.

In one form, the driver member comprises an angularly displaceable driver annulus 161 having a base 162 and an annular sidewall 163 defined in part by a pivotal axis orthogonal to the plane of a casing side. The driver annulus 161 is preferably supported within [and in some forms by] a raised casing annular wall 164 that completely or partly surrounds the drive annulus and in some forms, the driver annulus is supported by an axial cylindrical sideways protrusion of the base 162 comprising a pin 166 that locates within a substantially circular aperture 165 in a side of the casing to comprise a pivotal joint as shown in FIG. 5.

Some locks includes means of releaseably restraining the driver member in the fully displaced position and to restrain the driver annulus 161 in the undisplaced position as shown in FIG. 5, including recesses 167 within the side of the driver annulus 161 and a ball 168 biased towards the annulus by spring 169, the spring and ball being located within a curved recess 170 within the driver annulus wall 164 with an opening beneath the front plate. When the driver annulus is in the fully displaced or the undisplaced position the ball is aligned with one of the recesses 167 so a moment has to be applied to the driver annulus 161 to displace the ball from the recess.

Some locks require: 1) the upper and lower elongated drive members to be counteracting, and 2) the fully displaced configuration to correspond with outwardly displaced drive members, and 3) the fully displaced configuration to correspond with upwardly lifted unlatching unlatching lever. To satisfy these requirements, a rearwardly disposed first joint 171 of the driver annulus 161 (FIG. 5) is operably connected to the upper drive member 159 and a forwardly disposed second joint 172 (FIG. 3) is operably connected to the lower drive member 160. The first and second pivotal joints in one form comprise pin joints (and herein the terms are used synonymously) comprising a pin extending sideways from one member to locate within the other member or a pin that extends from within apertures in each member to be relatively displaceable to at least one, importantly the first and second joints accommodate relative angular displacement. The term pin herein embraces a substantially right-angled return portion of a drive slide or drive member within an aperture of the connected part.

In other forms, (not shown) the joints comprise a sideway protruding pin of the driver annulus that extend into a substantially horizontal slot of rectilinearly displaceable cooperating member to connect the two in a slide follower relationship.

In locks complying with the above requirements, and as shown in FIG. 3 and other figures, the driver annulus 161 is connected to the upper elongated drive member 159 by an upper drive slide 173 that at one end cooperates in the first joint 171 and it is operably connected by a second joint 172 to the lower elongated drive member 160 by a lower drive slide 174. In some locks (not shown), the lower drive slide comprises a flat, plate-like vertically elongated member having a sideways protruding pin being part of the second joint that is supported within the casing adjacent a side (between a side and the bolt) and that extends from the bottom of the casing to provide a joint enabling connection to the lower elongated drive member. In some locks (and where there is insufficient space within the casing for the lower drive slide described above) the lower drive slide 174 is connected to the second joint 172 by an intermediate mechanism described below.

In some locks, as shown in FIG. 3 and other figures, the driver annulus 161 and each unlatching cam 101 are closely disposed (to require less space within the casing and for other reasons) and their respective pivotal axii are closely disposed. In some locks, the cylindrical portion of each unlatching cam 101 that is supported in an aperture 105 in a casing side is within a radius that in part defines the driver annulus 161. In some locks, each unlatching cam cylindrical portion 104 is within the driver annulus side-wall 163. In some locks, (not shown) where the driver member pivotal axis intersects each unlatching cam, the driver annulus is without the pin 166, and the driver annulus 160 is supported only by the annular wall 164.

The driver side wall, as shown in FIG. 2, includes a locking shoulder 175 and an unlocking shoulder 176 that are defined in-part by a driver drive recess 177 between them and each unlatching cam includes a drive arm 178 comprising (in an undisplaced disposition) a substantially horizontal radially extending blade-like arm that extends from the unlatching cam into the driver drive recess 177 to overlap the side wall 163. The locking shoulder 175 and unlocking shoulder 176 are angularly spaced such that when the driver annulus 161 and the unlatching cam/s is undisplaced as shown in FIG. 2, the drive arm/s 178 abuts the locking shoulder 175 and when the active unlatching lever is lifted to fully displace the driver annulus 161 (to actuate remote engaging members to their fully displaced positions) the drive arm 178 engages the locking shoulder 175 to displace it downwardly, and when the active unlatching lever is returned to the undisplaced position the drive arm 178. correspondingly displaces to a position where it abuts the unlocking shoulder 176.

When the active unlatching lever is displaced downwardly, the drive arm 178 displaces the unlocking shoulder 176 upwardly to displace the remote engaging members from the fully displaced position, during which displacement the unlatching rocker 87 is displaced to displace the latch bolt to the retracted position—with a fully retracted latch bolt corresponding to an undisplaced driver member.

In the egress locks described below, where there is a pair of unlatching cams and unlatching levers, either unlatching lever may be separately actuated (to become the active one) as described immediately above while the other unlatching cam and other unlatching lever remain undisplaced.

In some pivotal and rectilinear locks, the lower drive slide 174 is disposed rearwardly of the casing to comprise a vertically elongated, substantially rectilinearly displaceable drive slide as shown in FIG. 3, and in some forms comprises a substantially cylindrical rigid or semi-rigid member. The second joint (FIG. 4) is connected by an angled intermediate member 179 to an intermediate rocker 180 by a pin joint 181, the intermediate rocker 180 extending from a pivotal joint 182 shared with the casing and located adjacent the front plate to its free end 183 disposed rearwardly of the casing. The free end also shares a pin joint 184 with the rearwardly disposed lower drive slide 174 that extends from the pin joint 184 towards the lower end of the casing. The intermediate rocker 179 and intermediate member each have a pivotal axis orthogonal to a side of the casing.

The mechanism described immediately above, is particularly relevant to locks where the latch bolt first portion is to have maximum width within the constraints of the casing width and where there is no space between the casing sides and the latch bolt for other components.

In normal usage, rotation of the driver annulus 161 in a locking direction by lifting the free end of an unlatching lever 109 or 108 drives the upper drive slide 173 upwardly to displace the upper drive member 159 upwardly and drives the lower drive slide 174 downwardly by causing the intermediate member 179 to pull the intermediate rocker 180 downwardly to displace the lower drive member 160 downwardly. Preferably the upper drive member 159 and lower drive member 160 displace simultaneously in opposite directions and in forms of the invention, the total displacement of each is identical (although at any intermediate position this may not be so)—the lengths of the intermediate member, the length of the intermediate rocker and the location of the joints being configured to provide such. Rotation of the driver annulus 161 in an unlocking direction by lowering the free end of an unlatching lever 108 or 109 displaces the lower drive slide upwardly.

The driver annulus 161 in some embodiments is further configured to include a secondary driving shoulder 185 (FIG. 2) of the driver annulus 161 and a secondary driven shoulder 186 (FIG. 2) of the unlatching rocker 87 configured such that as the driver annulus 161 is displaced in a locking direction, the secondary driving shoulder 185 can engage the secondary driven shoulder 186 (if it is so disposed) to displace the secondary driven shoulder 186 in a forward direction to outwardly displace the bolt. The components are configured such that the secondary driving shoulder of a fully displaced driver annulus abuts the secondary driven shoulder of an unlatching rocker that corresponds to a fully (outwardly) displaced bolt. This functionality described immediately above is particularly applicable to locks for doors having seals where the door is restrained from properly closing by the seal.

In some pivotal and rectilinear locks, as shown in FIG. 5, the deadlocking slide 110 is connected to a vertically elongated blade like driver locking slide 187 by a pin joint 188 comprising an aperture in the slide and a protruding cylindrical pin of the deadlocking slide foot 119. The driver locking slide 187 has disposed from the aperture has a stop shoulder 190 that is displaceable into a circumferential driver locking recess 191 of the driver annulus 161 to restrain it from being displaced from the fully displaced position. In some locks, there is also a circumferential subsidiary locking recess 192 of the driver annulus that is utilized to restrain it from being displaced from the undisplaced position. It should be understood that the locking provided by the driver locking slide is additional to the locking provided by the deadlocking slide cooperating with the bolt as described above.

In forms of the invention, the first and second joints 171 and 172 are equidistance (at a radius r) from the driver annulus 161 pivotal axis and on substantially opposite sides of the pivotal axis and the first joint 171 and the annular driver 161 pivotal axis are in the same horizontal plane when the driver is angularly disposed half way between the undisplaced and fully displaced positions. The lower drive slide 174 extends vertically downwardly within a casing channel 193 along the inside rear casing wall of the casing and the upper drive slide 173 extends upwardly along an inside edge of the casing. At the lower and upper ends respectively each drive slide 174 and 173 includes a dog leg portion 194 that extends to a tail portion 195 having a longitudinal axis that is substantially midway between the casing sides. The tail supports a substantially cylindrical fitting 196, shown in FIG. 4, having a slot 197 in a head 198, the cylindrical portion being externally threading 199 so that it can receive and mate with an internally threaded end 200 of the associated drive member. The fitting has a longitudinally elongated aperture 201 and a cone portion through which the tail 195 extends to be crimped to retain the fitting 196 on the tail 195. The slot 197 receives the orthogonal portion of the dog-leg 194 to restrain the fitting against rotation.

The inventions herein include means to assemble drive members to a hollow frame wing; this invention being applicable to the pivotal and rectilinear locks described herein where the cone portion (or adjacent to the crimped portion) is connected to a flexible elongated cord 202 that the drive members comprise tubes. During fitting to a hollow frame wing, each cord 202 is threaded within the closing edge hollow frame from the lock body to the associated open end of the frame. The cord portion external of the wing is then threaded from one end to the other of the associated drive member. The drive member is partly inserted into the hollow frame and the external end of the cord is pulled to make the cord between the fitting and the internally threaded portion of the drive member taut. The drive member (tube) is then slid along the cord 202 till it is accepted by the fitting—the taut cord guiding the tube into engagement with the threaded fitting.

In some locks, the same arrangement described immediately above, is employed in relation to the upper drive member. In other locks, as shown in FIG. 3, the upper drive slide can be angularly displaced to facilitate fitting whereby the upper drive slide is inserted into the hollow section comprising the lock edge of the wing and the lock body is then inserted into the hollow section during which, the upper drive slide assumes a vertical disposition

In some pivotal and rectilinear locks, as shown in FIG. 2, the remote locks are connected by Bowden Cables 203 that operate in the same direction whereby upwards displacement of the inner cables (being elongated drive members) in response to an unlatching lever being upwardly displaced causes each remote engaging member to be displaced towards an fully displaced disposition—this lock otherwise functioning as the lock described above that employs rigid drive members. The lower inner cable 204 has right angled return portion 205 that locates in a recess 206 in the driver annulus 161 to comprise an alternative first joint 207 that is substantially coaxial with the first joint 171 but on the opposite side of the drive annulus 161 and the upper inner cable 208 has a right angled return portion 209 that locates in a recess 210 in the driver annulus to comprise the first joint 171. In these locks, the casing channel 193 is adapted to provide an open channel 211, open from the rear of the casing to extends from the driver annulus 161 to the lower end of the casing to provide passage for the lower Bowden Cable 212 and to enable the cable to be assembled into the channel. Adjacent to the driver annulus 161 is a slotted aperture 213 in a fixed casing portion to receive and restrain a sideways protruding shoulder 214 of the lower outer cable end 214A and adjacent to the driver annulus there is a slotted aperture 215 to receive and restrain a sideways protruding shoulder 216 of the upper outer cable end 216A. In some locks, the outer Bowden Cable comprises a semi-rigid tube. In some cases, the inner cable comprises a single strand of resilient wire that offers some resistance to buckling.

In some locks, as shown in FIG. 8, there is an unlatching lever 108 having a substantially cylindrical shank portion 217 that is supported within a substantially cylindrical through aperture 218 in an substantially cylindrical underside boss 219 of the handle backplate 220, the aperture having an opening to the external face of the back plate and terminating within the underside of the backplate in a substantially circular annular washer-face 221. The shank preferably has a sideways protruding retention shoulder 222 that in use overlaps and abuts the washer-face 221 and the underside boss is longitudinally slotted 223 to provide passage for the retention shoulder 222—the slot 223 and retention shoulder 222 being configured such that in normal operation they are never aligned. In usage, the shank 217 is fed through the slot 223 and it is then rotated so that the retention shoulder abuts the annular washer-face.

In other handle sets, the unlatching lever is retained by a circlip fitted to the shank of the unlatching lever beneath a disc-like member as is common.

The inventions herein include a springing system for levers that provides for simple and ready conversion between handing types and without the use of hand tools and biases the unlatching lever towards an undisplaced disposition irrespective of the direction in which it has been displaced; this invention being applicable to the pivotal and rectilinear locks described herein.

In a preferred embodiment as shown in FIG. 8, the unlatching lever has the shank portion 217 described above and a cupped member 224 that envelops a protruding portion 225 of the shank portion 217 and envelops the boss 219 by extending up the side of the boss. The cupped member 224 has an axial aperture 226 to provide passage for and to mate with the drive shaft 107 that also mates within the axial drive recess 109 of the shank whereby to operably couple the cupped member, shaft and unlatching lever. [The cupped member 224 for the exterior unlatching lever 108 takes two forms; that shown in FIG. 8 for egress locks having a sideways protruding portion with a locking recess; and a substantially hollow cylindrical member able to be rotated 360 degrees relative to the back-plate—this latter form being applied always to the cupped member for interior unlatching lever 109].

The cupped member 224 includes sideways disposed opposed side apertures disposed from its pivotal axis. One of the apertures 228 disposed towards the unlatching lever arm is occupied by a right-angled return portion 229 of a vertically elongated extended tension spring 230 that is connected at the upper end to a rail 231 of the underside of the back plate, the spring urging the cupped member 224 to rotate about its axis and hence the unlatching lever to displace upwardly; the spring having a return portion 232 on the other side of the rail to comprise a U shaped spring end 233 so at to be retained adjacent the rail. The other apertures 234 disposed away from the unlatching lever arm is occupied by a right-angled return portion 235 of a vertically elongated stronger (substantially unextended) tension spring 236 that is connected at the upper end to the rail 231, the stronger spring acting as a stop means to restrain the cupped member against rotation from the undisplaced position of the cupped member by the softer spring, the spring having a return portion 237 on the other side of the rail to comprise a U shaped spring end 238 so at to be retained adjacent the rail.

In usage, downward displacement of the unlatching lever 110 causes the softer spring to stretch (more) to urge the cup with even greater force towards the undisplaced disposition while the stronger spring exerts no force being displaced upwardly substantially as a rigid member as the U shaped end 238 of the stronger spring slides over the rail while being retained adjacent the rail; and upwards displacement of the unlatching lever causes the harder spring to stretch and the softer spring to become less stretched with the overwhelming force of the stronger spring urging the cup towards the undisplaced disposition.

During fitting, the interior unlatching lever 109 is convertible between left and right handed configurations by replacing the shaft with a temporary fitting-shaft (not shown) that connects the unlatching lever and cupped member without protruding significantly from the cupped member and rotating the unlatching lever to a downwards position beyond the normal operating range (in which range, in usage it is retained by the shaft). The stronger spring is configured such that the return 237 is displaceable from behind the rail when the unlatching lever is so downwardly displaced to enable the spring end 238 to be disconnected from the rail. When the lower end 229 of the softer spring has displaced to be past the pivotal axis of the shaft recess (and the fitting-shaft), the stronger spring end 238 is re-attached to the rail by placing the end portion 237 behind the rail on the opposite side of the spring end 233. Unlatching lever displacement back into the normal operating range causes the U shaped end 238 to be engaged with the rail as described above. So as the unlatching lever displaces towards the undisplaced position the spring end 238 displaces outwardly by sliding along the rail to assume an undisplaced position that is on the opposite end of the rail from which it was before re-handing and the soft spring end 233 is similarly displaced to an end of the rail opposite that from which it was released. At that time, the fitting-shaft is removed.

The cupped member before fitting of the shaft, abuts the boss to be supported by the boss but during fitting of the shaft, the cupped member is preferably slightly displaced to be supported by the shaft with operating clearance between the cupped member 224 and the side walls of the underside boss 219 so that the friction exerted on the moving assembly (of cupped member, unlatching lever and drive shaft) is minimized.

After fitting, the cupped member is restrained horizontally by the wing against which it is fixed. The rail comprises a simple, horizontally elongated member (preferably cylindrical in form), having a right angled return portion 239 at each end that is inserted into apertures 240 in the underside of the back-plate. In some forms of the invention (where the unlatching lever is not required to be displaced upwardly) the harder spring can be replaced by an in-extendable member that acts only as a stop to restrain the unlatching lever against rotation in one direction and in some forms this comprises a link having return on each end as described above.

The lock can, within this invention have a unlatching lever reversed simply by rotating the unlatching lever to the other side when the drive shaft is not within the cupped member because without the shaft there need be no connection between the unlatching lever and cupped member (if the sideways protruding shoulders 222 are not coupled to the cupped member). In this case however, in one handing (left or right) unlatching is achieved against a softer spring, while in the other, unlatching is achieved against the harder spring.

Although (in the locks described immediately above) there is provision for operating remote locks, it will be appreciated that they may not, and need not, always be employed with the locks described above as the locks operate quite satisfactorily without remote locks—for this reason it can be said that the remote locks or remote engaging members are operably connectable to the driver (and lock) because they can be connected when so desired. In the context of this specification, a remote lock or remote engaging means comprises a remote engaging member that embraces a simple plunger like member, each said remote engaging member being connectable directly or indirectly to a vertically elongated drive member that is connectable to a drive slide or to the driver annulus and they include more sophisticated device where a remote engaging member is actuated by an intermediate mechanism that in some cases includes a remote lock casing and in some cases includes means for separately deadlocking the remote engaging member and where independent deadlocking is effected by displacement of the driver annulus. The fully displaced configuration of a remote engaging means is that in which it acts to restrain the wing in which it is supported and in the case of a plunger-like member it is the extended position where it protrudes from the wing.

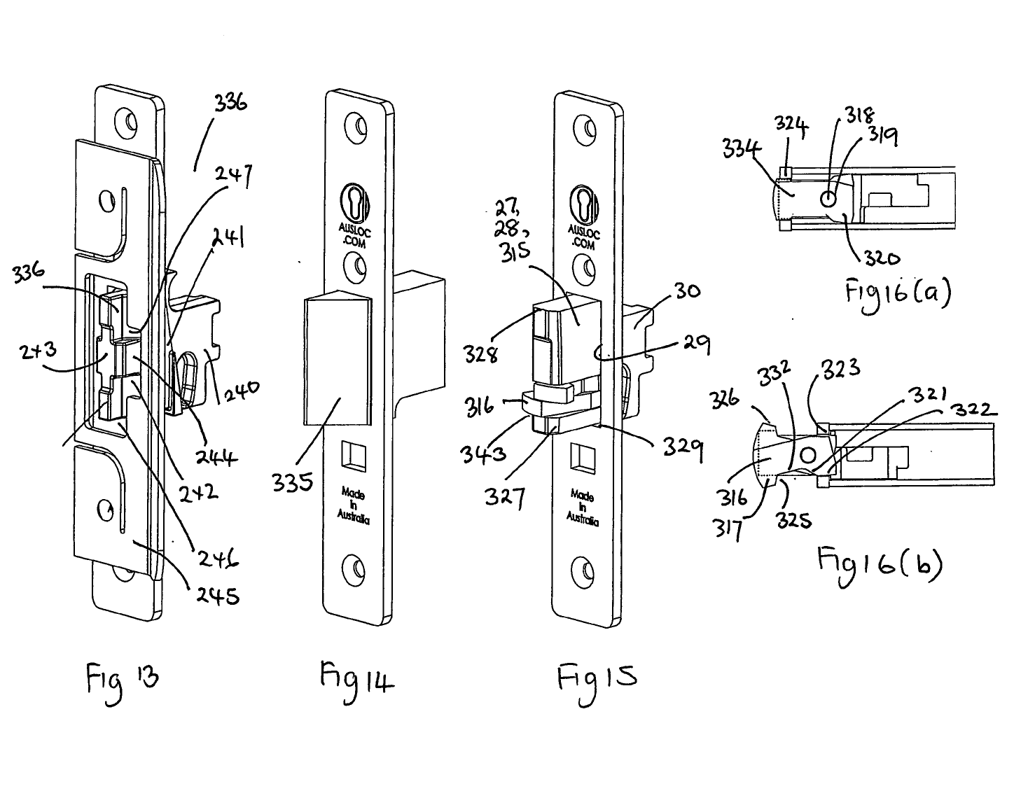

The inventions herein include a bolt that can be driven outwardly by operation of the unlatching lever; this invention being applicable to some rectilinear locks described herein. The driven bolt 240, as shown in FIG. 13, (that may or may not be outwardly biased) has a first portion comprising a substantially prism-like solid having substantially parallel sides 241 a distance of D apart that on one side is connected to an angled portions 242 that towards the leading end 243 is connected to an offset side 336 defined by a plane parallel the plane of a side. Preferably the offset bolt is so configured on both sides and the offset planes are horizontally spaced a distance of d−the angled sides reducing the bolt width by D−d. The driven bolt preferably include at least one full width bridge portion 244 within the generally angled portions described above comprising portions of the parallel sides. This driven bolt 240 is employed with a driving strike plate 245 that includes a substantially rectangular aperture 246 as elsewhere described having a width substantially the same as the bolt (plus operating clearance) but further including an additional clearance aperture 247 shown in FIG. 13, extending exteriorly from the aperture and in a position adjacent the bridge portion. The clearance apertures extend horizontally for a distance not less than by ½[D−d] defined above and for a vertical height not less than the height of the bridge portion plus half the vertical clearance between the aperture and general bolt.

This driven bolt 240 and driving strike plate 245 together enable the bolt of a lock in a hinged wing that is still open by ½(D−d) to partly latch through the action of the leading end portion of the bolt (defined by planes d apart) entering the aperture 246. Once the bolt is partly in the aperture, the bolt can be driven outwardly to the fully extended position to displace the lock casing and the wing in which it is fixed to a fully closed position—this displacement taking place as a result of the angled side of the bolt sliding over a peripheral edge of the strike plate aperture. The bolt can be driven outwardly by displacement of the driver annulus as described above, and the driven bolt can also be driven outwardly by deadlocking slide displacement as described above. Driven bolts (both advanced and otherwise) find application in wings that must be closed against a seal and that require a force to be applied to fully close the wing.

The integers described above are configurable so:
the upper and lower drive members each displace 15 MM
the bolt when fully extended protrudes 16 MM from the front plate
the bolt has a width of 12. MM
the lock body has a width of 15.5 MM
the backset is 30 MM
the casing depth is 40 MM
the unlatching levers rotate less than 40 degrees to unlatch
the distance between cylinder and unlatching lever axii of 85 MM
the bolt is in the middle of the front plate
the front plate is interchangeable
the control rocker interchangeable
the backset can be changed by the addition of spacers
the casing length does not greatly exceed 155 MM
the bolt is angularly displaceable or rectilinearly displaceable

### Complete Locks Comprised of the Integers Described Above

Basic Locks—Pivotal and Rectilinear

These locks include a lock body 5 comprising a casing 12, front plate 6, a latch bolt, a rectilinearly deadlocking slide 110, at least one unlatching cam 103, an unlatching rocker 87, handle sets including an interior 109 and an exterior unlatching lever 108 each connected by the single shaft 107, and electively an angularly displaceable interior locking lever 139 connected to a locking cam 141 by a spindle 140, and electively a free-rotation-double cylinder 120 having a first cam 148 and cylinder screw 155 enabling the lock to be characterized by a first and a second locked configuration. Rectilinear types having an advanced latch bolt also include an auxiliary bolt 46 and a control rocker 56. Pivotal types having an advanced latch bolt include a pivotal auxiliary bolt 69 and a control slide 80. These locks are further configurable to electively include a driver annulus 161 and an upper 159 and a lower drive member 160 (comprising Bowden Cable or rigid members) connected to remote engaging members. The locks are further configurable to have any of the bolts and strike plates described herein including those with the definitions.

Standard locks in general, have a deadlocking slide that supports an outwardly spring biased sideways displaceable ball 249 supported within a recess in the deadlocking slide, as shown in FIG. 2, to releasably restrain the deadlocking slide from leaving pre-determined configurations; the ball being engageable in recesses 250, 251, 252 in a side of the casing that correspond respectively to an undisplaced deadlocking slide 110, a deadlocking slide in the second locked configuration and a deadlocking slide in the first locked configuration where in the second locked configuration, the deadlocking slide is not displaced upwards sufficiently to enable the first cam arm to depart the drive recess to abut the exit shoulder 154.—in both locked configurations the engaging shoulder of the deadlocking slide being behind the engageable shoulder of the bolt to deadlock the bolt.

Preferably, the deadlocking slide supports a slide spring 134 to bias the fist cam arm against leaving the drive recess, in which case the position of the deadlocking slide in the second locked configuration can be substantially the same position as it is in the first locked configuration and the recess 251 can be omitted.

To exclude locking to the first configuration a stop pin 341 is included as shown in FIG. 3, that passes between casing sides in the locus of displacement of a horizontal shoulder 342 of the deadlocking slide to restrain the deadlocking slide from being displaced upwardly from the position corresponding to the second locked configuration.

Egress Locks—Pivotal and Rectilinear

Egress locks (unless otherwise stated) referencing FIG. 9, are as the standard locks described above but the angularly displaceable interior locking member is operably connected to a stop blade 253 as described below within the exterior handle assembly—the locking member 139 being displaceable to displace a locking cam 139 to displace a rectilinearly deadlocking slide into the deadlocking configuration while simultaneously displacing the stop blade 153 to restrain the exterior unlatching lever against displacement. The deadlocking slide is displaceable from the deadlocking configuration by operation of the interior locking lever 109 as described below.

The exterior unlatching lever 108 is connected to an outer unlatching cam 103(E) by an exterior shaft 248(E) and the interior unlatching lever 109 is connected to a separate inner unlatching cam 103(I) by a separate interior shaft 248(I)—each drive shaft mating with its associated unlatching cam and unlatching lever and each unlatching cam being supported adjacently each other and each having an unlatching arm as described above and each being independently actuatable to cause the latch bolt to retract and where applicable each including a drive arm as described above whereby each is independently actuatable to actuate the driver annulus between its extreme dispositions. The spindle 140 of egress locks has passage through (and with which it mates) the aperture 144 to mate within a spindle recess 254 of a lever locking cam 255, as shown in FIG. 8, supported on the underside of the exterior handle backplate 220 by a shaft portion that protrudes into a recess in the underside of the back-plate.

The locking cam is operably connected to a deadlocking slide configured as an egress deadlocking slide 256 by a locking cam arm 257 having a displaceable free end portion that overlaps a portion of the egress deadlocking slide, this free end supporting a sideways protruding pinned shoulder 258 within a substantially horizontal slotted recess 259 in a side of the egress deadlocking slide. The egress deadlocking slide and locking cam mate without free displacement.

The egress deadlocking slide 256 as well as including the engaging shoulder 112 described above, also includes a ramped unlocking shoulder 260 that lies in the same plane (a plane parallel a casing side) as the unlatching rocker 87 and in a third locked configuration both the unlocking shoulder 260 and engaging shoulder 112 are rearwardly disposed of the bolt, the engaging shoulder 112 to restrain the bolt from being inwardly displaced and the unlocking shoulder 260 to be displaceable by the unlatching rocker as it displaces to retract the bolt—(Note: the ramped unlocking shoulder 260 does not extend into the locus of the bolt). The unlatching rocker is amended to comprise an egrees unlatching rocker where the second arm includes a nose portion 261 that is able to engage the unlocking shoulder 260 as it rearwardly displaces to displace the egress deadlocking slide and to subsequently cause the bolt to retract.

In egress locks, the bolt drive recess 92 is of sufficient width to enable the unlatching rocker drive pin 91 to freely displace sufficiently (while the bolt remains substantially undisplaced) to enable the nose portion 261 to slide up the unlocking shoulder 260 to displace the egress deadlocking slide 256 downwardly whereby to displace the engaging shoulder 112 from the engageable shoulder 113 to enable the bolt to be inwardly displaced by further unlatching rocker 187 displacement while simultaneously displacing the locking cam to drive the spindle 140 to displace the lever locking cam 255 to unlock the exterior unlatching lever. [Alternatively if deadlocking is not required, the egress deadlocking slide may just include a ramped or radiused unlocking shoulder]

The lever locking cam 255, as shown in FIG. 8, has at least one and preferably a pair of opposed arms 262 situated one on each side of its pivotal axis each terminating in an end shoulder 263. The vertically displaceable stop slide 253 supported between the side walls 264 of the exterior back plate is biased by a compression spring 265 towards the lever locking cam 255 so that in an undisplaced position of the stop slide 253, a substantially horizontal lower edge 266 of the stop slide 253 abuts the end shoulders 263 to bias the lever locking cam 255 towards an undisplaced position—the compression spring 265 being within a vertically elongated spring slot 271 acting downwardly on the lower end 272 of the spring slot 271 while acting upwardly on a boss 273 of the backplate.

The horizontal lower edge 266 includes opposed entrances 267 to a curved recess 268 (defined by a radius). When the lever locking cam 255 is displaced in either direction to displace the stop slide 253 upwardly to the locking configuration, one end shoulder 263 enters the recess 268 to restrain the stop slide 253 in the locking configuration. In the locking configuration, a stop blade 269 is within a stop slot 270 of an adapted cupped member 224.

The recess 268 is configured such that the stop slide 253 cannot be displaced to displace the lever locking cam 255 (this being possible by spindle rotation alone) because the vector defining the normal to the surface of the curved surface is configured to pass through the pivotal axis of the lever locking cam.

The components are configured such that when the locking lever and spindle are undisplaced, the exterior unlatching lever 108 is unrestrained but when the locking cam has a disposition corresponding to the third locked configuration, the stop blade is within the recess 268. In usage, when the interior unlatching lever 109 is pushed down to retract the bolt, the egress deadlocking slide 256 is displaced to angularly displace the locking cam to angularly displace the spindle to unlock the exterior unlatching lever. As will be appreciated, the exterior unlatching lever can be both locked and unlocked by the cylinder from either side and by the locking lever 139 from the interior.

Egress locks in general, have a deadlocking slide that supports an outwardly spring biased sideways displaceable ball 249 supported within a recess in the deadlocking slide, as shown in FIG. 2, to releasably restrain the deadlocking slide from leaving pre-determined configurations; the ball being engageable in recesses 250, 251, 252 in a side of the casing that correspond respectively to an undisplaced deadlocking slide 110, a deadlocking slide in the third locked configuration and a deadlocking slide in the first locked configuration where in the third locked configuration, the deadlocking slide is not displaced upwards sufficiently to enable the first cam arm to depart the drive recess to abut the exit.—in both locked configurations the engaging shoulder of the deadlocking slide being behind the engageable shoulder of the bolt to deadlock the bolt.

Preferably, the deadlocking slide supports a slide spring 134 to bias the fist cam arm against leaving the drive recess and the recesses 251 and 250 are connected to comprise an oval so the ball has free vertical passage within this oval—the egress deadlocking slide and locking cam being biased from leaving their respective undisplaced positions by biasing of the lever locking cam urging it against displacement from the undisplaced disposition.

To exclude locking to the first configuration a stop pin 341 is included as shown in FIG. 3, that passes between casing sides in the locus of displacement of a horizontal shoulder 342 of the deadlocking slide to restrain the deadlocking slide from being displaced upwardly from the position corresponding to the third locked configuration.

It should be noted that if the lock is locked to the first locked configuration, it cannot be unlocked by use of the interior unlatching lever.

Deadlatching Locks—Pivotal and Rectilinear

Deadlatching locks, referencing FIG. 9, (unless otherwise stated) are as the standard locks described above but are limited to employing an advanced latch bolt and the deadlocking slide modified to comprise a deadlatching deadlocking slide 275 as described above that additionally includes a spring wing 276 that protrudes into a spring recess 277 as shown in FIG. 9, of the casing to be acted on by a compression spring 278 supported beween the spring wing 276 and a casing wall 279—the spring 278 urging the deadlatching deadlocking slide 275 towards the advanced bolt. (With a view to standardising components, this deadlocking slide can be substituted for the deadlocking slide described above in which case, the spring wing performs no function and the spring is omitted).

The locking cam in this type of lock, is modified to comprises a deadlatching locking cam 280 that is connected with free movement to the deadlatching deadlocking slide 275 by a cam arm 281 having a displaceable free end portion having an upper cam shoulder 282 and a lower cam shoulder 283 within a wide substantially horizontal drive slot 285 within the deadlocking slide whereby to mate with relative free displacement such that when the deadlocking slide has been displaced against biasing (from the deadlocking configuration) a position where it can no longer restrict the bolt movement (a position adjacent to the undisplaced position), the locking lever 139 and deadlatching locking cam 280 can be further angularly displaced to cause the lower cam shoulder 283 to leave the drive slot 285 by sliding along a lower exit shoulder 286 of the said slot, said exit shoulder 286 in this configuration being defined in part by a vector normal to the surface that passes through the pivotal axis of the locking cam. When so configured, the deadlatching deadlocking slide 275 is restrained against displacing towards the latch bolt by the deadlatching locking cam 280—this configuration being a spring-loaded configuration.

Where a first cam 148 is included in the lock, the first cam 148 is actuateable to downwardly displace the deadlatching deadlocking slide 275 against biasing means 278 to cause the upper shoulder 287 of the drive slot to engage the upper shoulder 282 to cause it to displace downwardly so that when the deadlatching deadlocking slide is close to the undisplaced position described immediately above, the lower drive shoulder 283 is adjacent the lower exit shoulder 286. At this point, a downwardly protruding accelerator shoulder 289 of the horizontal slot (that disposed closer to the pivotal axis of the locking cam than the free end portion) is adjacent the upper side 290 of the deadlatching locking cam arm 281, and it is configured such that further downwards displacement of the deadlatching deadlocking slide 275 causes the accelerator shoulder 289 to engage the upper side 290 to rotate the deadlatching locking cam 280 to displace the lower cam shoulder 283 to overlap the lower exit shoulder 286. Subsequently, when the deadlatching deadlocking slide 275 ceases to be driven by the first cam 148, the deadlatching deadlocking slide is upwardly displaced by the spring 276 till it engages the overlapping lower cam shoulder 283 that is now within its locus of movement. This causes the deadlatching deadlocking slide 275 to be restrained against further displacement; and in this configuration, the accelerator 289 is disposed from the upper side 287 enabling the cam arm to be displaced later, to free the deadlocking slide.

In usage, the locking member 139 can be actuated to release the deadlatching deadlocking slide 275 from the spring-loaded configuration to allow it to be displaced by the spring 278 to abut the underside edge of the bolt. In the case of rectilinear bolts, when the bolt displaces during latching the lower edge of the bolt slides over the leading end 213 of the deadlocking slide while restraining the deadlatching deadlocking slide 275 against biasing by means 278, and subsequently when the bolt becomes fully extended, the deadlatching deadlocking slide (no longer restrained) is displaced by biasing means to deadlock the lock.

In pivotal locks, the leading end 114 of the pivotal deadlatching deadlocking slide 334 (once release, displaces to abut a continuously curved portion of the bolt return portion so that when the bolt is displaced during latching, the bolt curved portion slides over the leading end 114 of the deadlatching deadlocking slide while restraining it against biasing means, and subsequently when the pivotal bolt becomes fully extended, the deadlatching deadlocking slide 334 is displaced by biasing means to deadlock the lock.

To unlatch the lock, either the locking lever 139 or a cylinder can be operated to drive the deadlatching deadlocking slide 275 from behind the bolt and into the spring-loaded configuration after which an unlatching lever is operated to unlatch the lock. However, if the lock has been locked to a first locked configuration it can only be unlocked from this configuration by actuation of the first cam.

Preferably, the deadlocking slide supports a slide spring 134 to bias the fist cam arm against leaving the drive recess and the position of the deadlocking slide in the second locked configuration is configured to be substantially the same position as it is in the first locked configuration.

In deadlatching locks, the outwardly biased ball 249 is excluded from all embodiments and to exclude locking to the first configuration a stop pin 341 is included as shown in FIG. 3, that passes between casing sides in the locus of displacement of a horizontal shoulder 342 of the deadlocking slide to restrain the deadlocking slide from being displaced upwardly sufficiently to enable the first cam to depart the drive recess.

The deadlatching capability described above can be included within the pivotal and rectilinear egress locks described above by employing a deadlatching locking cam and a deadlatching deadlocking slide having a leading end identical to that of the egress deadlocking slide and a stop pin to limit the travel of the deadlatching deadlocking slide from the third locked configuration. In this lock the biasing of the deadlocking slide must be strong enough to overpower the biasing of the locking slide within the exterior handle assembly.

Such a combined lock functions as an egress lock with the added functionality that each time the wing is closed, the deadlocking slide is driven to the third locked deadlocking configuration by biasing means with this displacement causing the locking cam to rotate to rotate the spindle to displace the lever locking cam 255 to lock the exterior unlatching lever.

Alternative Deadlatching Locks—Rectilinear

In other deadlatching locks, referencing FIG. 10, (unless otherwise stated) are as the standard locks described above but are limited to employing an advanced latch bolt and the spring loaded ball 249 is omitted from all embodiments to provide free movement to the deadlocking slide.

In these locks, the unlatching levers are omitted and the bolt is displaceable to the retracted position by actuation of the deadlocking slide in response to rotation of the first cam 148 and/or by operation of the locking member 139. In these locks, the deadlocking slide is modified to comprise a modified deadlatching deadlocking slide 298 where the foot 119 is connected to a vertically elongated blade like link 291 that extends upwardly beyond while overlapping a connecting arm 292 of a modified unlatching cam 293. A pinned protrusion 294 of the foot preferably comprising a cylindrical pin protrudes into an aperture 295 of the link to connect the two members. The connecting arm has a sideways pinned protrusion 296 that extends into a vertically elongated upper aperture 297 within the link to provide connection with free movement. The modified unlatching cam 293 includes the driving shoulder 104 that is engageable with the unlatching rocker 87 as previously described and is otherwise the same as that described above.

The lock includes a deadlocking slide configured as a modified deadlatching deadlocking slide 298 has a curved leading end 299 that extends rearwardly while extending upwardly to provide clearance for the bolt to displace inwardly.

In the deadlocking configuration, the modified deadlatching deadlocking slide is fully upwardly displaced and cooperating with the bolt as described elsewhere by an engaging shoulder 112 of the said modified deadlatching deadlocking slide 298 being behind the engageable shoulder 113 of the bolt, but during displacement of the modified deadlatching deadlocking slide 298 and link 291 from the deadlocking position, the first part of the displacement is devoted to removing the engaging shoulder 112 from behind the engageable bolt shoulder 113 and during this displacement of modified deadlatching deadlocking slide and link, the pin 296 slides freely relatively within the upper link drive recess 297 while the modified unlatching cam 293 remains undisplaced. During the remainder of the link displacement, the pin 296 abuts the upper end of the link recess 297 to be acted on by the link whereby to be displaced downwardly to displace the modified unlatching cam 293 to displace the unlatching rocker 87 to cause the bolt to be inwardly displaced. The lock is configured such that the modified deadlatching deadlocking slide 298 is in the undisplaced configuration when the bolt is fully retracted.

In usage in rectilinear locks, the modified deadlatching deadlocking slide in the pre-latching configuration abuts the underside edge of the bolt. When the bolt displaces during latching the lower edge of the bolt slides over the leading end 299 of the modified deadlatching deadlocking slide while restraining it against biasing means, and subsequently when the bolt becomes fully extended, the modified deadlatching deadlocking slide is displaced by biasing means to deadlock the lock.

When a locking lever is included, the lock includes a slide spring 134 to restrain the first cam within the drive recess of the deadlocking slide to provide a second locked configuration—since the position of the deadlatching deadlocking slide is the same position for both the first and second locked configurations.

Second French Door lock

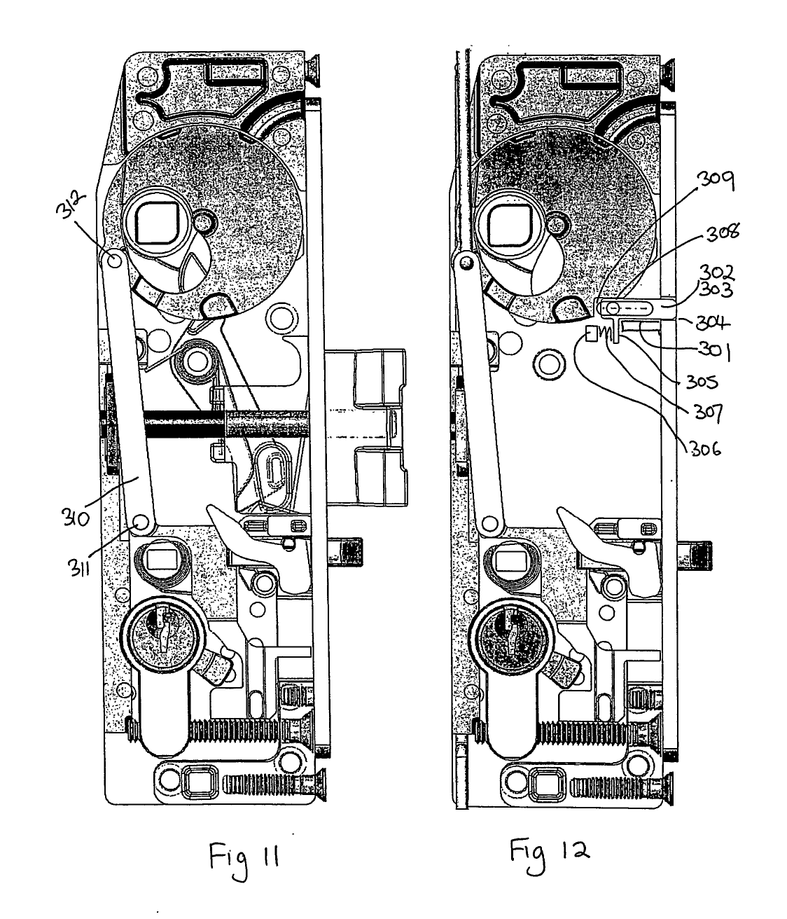

Other locks referencing FIG. 12, (unless otherwise stated) are as the standard locks described above but the latch bolt, unlatching cam, auxiliary bolt and locking cam are omitted to provide a lock for the subsidiary door (that which has the strike plate attached) of a pair of French doors, the lock having one or a pair of remote engaging members operated by an unlatching lever as described above. These locks preferably include a horizontal plunger recess 301 of a casing fixed member that extend through to the driver annulus wall to expose the driver annulus. The plunger recess supports a locking plunger 302 having a first portion 303 that is horizontally displaceable against biasing means from a position where it protrudes from and through an aperture 304 in the front plate to a retracted position where it is substantially within the casing. The plunger has a sideways protruding wing 305 and rearward of this the casing has a finned protrusion 306 between which a compression spring 307 is located to outwardly bias the plunger.

The locking plunger has a return portion 308 that in the retracted position of the locking plunger engages in a peripheral recess 309 of the driver annulus 161 to restrain it from being displaced from the fully displaced position corresponding to extended remote engaging members. This locking plunger is depressed when the other door is closed and when the front plate of the lock supported in the other wing, slides over the locking plunger to depress it. By this means the second French Door is restrained relative to the door frame by the closing of the first French Door.

### COMPLETE CONVENTIONAL LOCKS COMPRISED OF THE INTEGERS DESCRIBED ABOVE

Conventional Passage Lock

A lock having either a rectilinear or pivotal latch bolt that can be operated by unlatching lever from either side at all times.

This lock has an outwardly biased pivotal or rectilinear latch bolt, at least one unlatching cam, an unlatching rocker, interior and exterior unlatching levers connected by a single shaft to the unlatching cam, no cylinder nor locking member and the deadlocking slide and locking cam may electively be included. This lock may electively be configured to operate remote locks.

Conventional Privacy Lock

A lock having either a rectilinear or pivotal latch bolt that can be operated by unlatching lever from either side at all times.except when the exterior unlatching lever is locked by locking lever (snib) on inside.

This lock is based on the egress lock and has a lockable exterior unlatching lever and a locking lever connected to the exterior handle set by a spindle that passes through the lock body; it only has a single unlatching cam, a single rod and the cylinder, the deadlocking slide and locking cam are omitted and the exterior handle set includes an exterior locking lever comprising hand operable coin slot that is connected to the locking cam by an extension to the spindle. Once locked by locking lever, the lock must be unlocked by locking lever to enable unlatching. The lock may be configured to operate remote locks.

Conventional Patio Lock

A lock where the deadlocking latch bolt is operated by unlatching lever from either side except when outside unlatching lever is locked by locking lever on inside. Automatic unlocking when inside unlatching lever is rotated or unlocked by locking lever.

This pivotal or rectilinear lock is based on the egress lock having a lockable exterior unlatching lever, an egress deadlocking slide, a locking lever, an egress locking cam, and unlatching levers connected by separate shafts to separate unlatching cams. The cylinder is omitted and the stop pin is included. The lock may be configured to operate remote locks.

Conventional Entrance Lock

A lock where the deadlocking latch bolt is operated by unlatching lever from either side except when outside unlatching lever is locked by locking lever or cylinder.

This pivotal or rectilinear lock is based on the egress lock but there is no locking cam and the spindle passes through an aperture in the casing to mesh in lever locking cam of the exterior handle assembly and the lock includes a stop pin to prevent the lock from being locked to the first locked configuration.

When the exterior unlatching lever is locked, the exterior unlatching lever may be operated after unlocking by key or locking lever. The lock may be configured to operate remote locks.

Conventional Entrance Lock

A lock where the deadlocking latch bolt is operated by unlatching lever from either side except when the outside unlatching lever is locked by locking lever on inside.

When the outside unlatching lever is locked, the exterior unlatching lever may be operated after unlocking by key or by rotating interior unlatching lever which unlocks the exterior unlatching lever or by operating locking lever. The lock includes a stop pin to prevent the lock from being locked to the first locked configuration.

This lock is an egress lock as described above. The lock described may be configured to operate remote locks.

Conventional Classroom

A lock where the deadlocking latch bolt is operated by unlatching lever from either side except when outside unlatching lever is locked by key from exterior. When the outside unlatching lever is locked, the latch bolt is retracted by rotating the interior unlatching lever or by unlocking the exterior unlatching lever by key and then operating exterior unlatching lever.

This lock is based on the egress lock but there is no locking cam and the spindle passes through an aperture in the casing to mesh in a lever locking cam of the exterior handle assembly and there is a stop pin to prevent the lock being locked to the first locked configuration. When the exterior unlatching lever is locked, the exterior unlatching lever may be operated after unlocking by key or locking lever. The lock may be configured to operate remote locks.

Conventional F91 Lock

A lock where the deadlocking latch bolt operated by unlatching lever from either side except when both unlatching levers are locked by key from either side.

This lock is as the standard lock described above. The lock electively includes a locking member. The lock may be configured to operate remote locks.

### Alternative: Functionalty and Integer Forms

A) Remote Locks Operated by Cylinder

Referencing FIG. 11, the driver annulus 161 is operably connected to the deadlocking slide 110 by a vertically elongated deadlocking slide extension 310 that preferably comprises a blade that extends along the rear of the lock and that has a lower end portion which shares a pin joint 311 with the foot portion of the deadlocking slide 110 and an upper end portion that shares a pin joint 312 with the driver annulus 161.

The deadlocking slide is preferably configured to displace about 11 MM as is common in security door locks, but if the axis of the pin joint 304 is a lesser radial distance from the axis of the annulus than the first pin joint and they are co-radial then a displacement by the deadlocking slide 110 causes a larger displacement of the drive slides 174 and 173 sharing the first and second pin joints as described previously. The vertically elongated drive members therefore can be displaced 15 MM by operation of the cylinder. In these forms of locks, the remote bolts are operated by actuation of the key and/or locking lever as is common in security door locks. The locks are configured such that the undisplaced configuration of the deadlocking slide 110 corresponds to the undisplaced configuration of the driver annulus 161. In these locks the drive members are connected to the driver annulus as described elsewhere herein.

The lock components described immediately above are also applicable to pivotal locks that can be configured to include a deadlocking slide extension.

B Cylinders

In some locks the first cam 148 comprises a cylinder cam 122 having a cam arm 123 as described above that is connected to at least one key operable barrel of a double cylinder 121. The cylinder, in fact, may comprise one of the following forms:

a free rotation single cylinder comprising a single key operable barrel within a cylinder housing operably connected with free movement to the cylinder cam 122 to enable the cam 122 to be displaced by barrel 330 rotation to a locking configuration and then the barrel 330 to be reverse rotated to an undisplaced position enabling key removal;

a free rotation-double-cylinder 313 comprised of opposed barrels 314 each connected with free movement to the same cylinder cam 122 such that the cylinder cam 122 is free (between limits) to be angularly displaced while the barrels 330 remain undisplaced, this type of cylinder being commonly used in security door locks in Australia to enable the cylinder cam 122 to be displaced by either barrel 330 to a locking configuration and then the barrel 330 to be reverse rotated to an undisplaced position enabling key removal while leaving the first cam 122 in the locking position, (this type of cylinder being distinct from the more commonly used double cylinders that employ clutches.) In forms of free rotation cylinders 331, a barrel is replaced by a hand operable turn knob.

Some cylinder comprise a separate subassembly while in others, the housing comprises part of the handle back-plate,

C) Exterior Locking Lever

In some standard, egress and deadlatching locks, there is an exterior locking lever, as described in [Watts AU 18474/2000] that hereby included by reference, that is operable to displace the lock into the second or third locked mode but which is not operable to displace the lock from the second locked mode.

D) Auxiliary Bolt

In some locks, the first auxiliary bolt first portion comprises a prism-like member as shown in FIG. 1, having a leading end 68 profiled on both sides to accommodate both left hand and right hand doors wherein the profiled portion on each side is curved, chamfer or otherwise profiled to facilitate latching wherein the auxiliary bolt is engageable on either side by a strike plate to be inwardly displaced by the strike plate during latching.

B) Latch Bolts

The advanced latch bolt first portion in some forms comprises a substantially prism-like solid 315 as shown in FIG. 15, and electively takes the following form:

The latch bolt in the fully extended position is extended so far that it could not latch with the strike plate unless it were restrained in the pre-latching configuration.

The latch bolt comprises a substantially prism-like solid having a first bolt portion of lesser width than the distance between the casing sides and the bolt aperture in the front plate is correspondingly of a lesser width that the dstance beween the casing sides—this configuration leaving portions of the front plate adjacent to the bolt aperture, protruding inwardly from the sides of the casing to provide engageable side shoulders. There is a horizontal slot 343 extending from one side within which there is a least one and preferably a pair of counteracting hooking arms 316 each angularly displaceable so that an outer hooked end 317 can protrude from a side of the bolt first portion to engage behind the aperture edge within a catch plate or strike plate whereby to become longitudinally engaged (this bolt suiting both hinged and sliding doors). Each arm is additionally supported by a vertical shaft 318 (that lies within a plane that passes equidistantly between the casing sides) that has passage through an aperture 319 in each arm, the shaft 318 defining the vertical pivotal axis of each arm. Each hooking arm terminates at the inner end in a control shoulder 320 that when the bolt is retracted, is adjacent an inside wall of the casing as shown in FIG. 16(a). This control shoulder includes an angled edge 321 connected to longitudinal portion 322. The bolt is configured such that as the bolt displaces towards the fully extended position, the angled edge 321 of each control shoulder 320 is brought into contact with the front plate bolt aperture inside edge 323 to be urged to displace inwardly to displace the hooks 317 outwardly—in this disposition the shaft 318 being outwardly disposed from the front plate bolt aperture inside edge 323 as shown in FIG. 16(b). When the bolt is fully extended, the longitudintal portion 322 is within the mouth 324 of the front plate to retain the hooks fully extended.

During inwards displacement of the bolt, the strike plate or catch plate aperture peripheral edge engages a second ramped edge 325 to urge the hooks torwards their respective retracted positions—the ramped edges defining the extend of an edge recess 332. The hooked end 317 and second ramped edge are configured such that leading portion 326 is still partly within the mouth 324 of the front plate when the bolt is in the pre-latching configuration and remains so until the portion 326 have entered the strike plate or catch plate aperture during latching. Alternatively, the recess 332 is omitted to provide alternative hooking arms 334 as shown.

The latch bolt has a leading end 327 profiled on both sides to accommodate both left hand and right hand doors wherein the profiled portion on each side is curved, chamfer or otherwise profiled to facilitate latching wherein the latch bolt is engageable on either side by a strike plate to be inwardly displaced by the strike plate during latching;

The latch bolt has radiused corners 328 to provide increased front plate strength and the corners 329 of the front plate aperture are also preferably radiused.

The latch bolt first portion in some forms comprises a substantially half a solid prism having a bevel 335 on one side, as shown in FIG. 14, that extends from top to bottom as is common in bevelled latch bolts and the latch either has or does not require a pre-latching configuration and accordingly either is or is not accompanied by an auxiliary bolt.

The latch bolt first portion in some forms comprises a hand actuatable bolt 336 and the driver annulus includes the secondary drive shoulder and the unlatching rocker includes the secondary driven shoulder, in some forms this bolt comprises a latch bolt as described above and in other forms the lock comprises a bolt as described but without the bolt biasing means.

1. A lock mountable to a displaceable wing including a casing and operating means including at least one hand operable unlatching lever operable in an unlatching direction to cause a corresponding unlatching cam to displace in an unlatching direction,
an engaging member supported by the casing and displaceable between a fully displaced disposition and a fully retracted disposition,
the unlatching cam being operably connected to the engaging member by an angularly displaceable unlatching rocker supported at a pivotal joint disposed between the engaging member and the unlatching cam, the unlatching rocker having a first arm operably associated with an unlatching arm of the unlatching cam and a substantially opposed second arm operably associated with the engaging member,
the unlatching cam being displaceable in an unlatching direction to cause unlatching arm to displace the first arm of the rocker to displace the second arm in the opposite direction to thereby cause the engaging member be displaced towards the fully retracted disposition.

2. A lock according to claim 1, wherein the at least one unlatching lever comprises an angularly displaceable unlatching lever having a free end disposed from its pivotal axis, said free end being displaceable downwardly in an unlatching direction and displaceable upwardly in an opposite direction.

3. A lock according to claim 1, including a displaceable deadlocking slide supported within the casing and characterized by a deadlocking configuration in which a leading end of the deadlocking slide and the engaging member co-operate to restrain the engaging member from being displaced from the fully displaced position.

4. A lock according to claim 3, wherein the deadlocking configuration is characterized by an engaging shoulder of the deadlocking slide being behind an engageable shoulder of the engaging member.

5. A lock according to claim 4, including a hand operable locking member operably connected to the deadlocking slide, the deadlocking slide being displaceable by the operation of the locking member.

6. A lock according to claim 4, wherein the locking member is operably connected to the deadlocking slide by a locking cam supported within the casing.

7. A lock according to claim 6, wherein the operating means comprises an interior unlatching cam corresponding to the interior unlatching lever and an exterior unlatching cam corresponding to the interior unlatching lever,
and wherein the locking member is operably connected to a lever locking cam supported within the exterior handle assembly,
said deadlocking slide being displaceable to the deadlocking configuration by the locking member simultaneously as the lever locking cam is displaced to a locking disposition where it causes the exterior unlatching lever to be restrained against displacement,
the deadlocking configuration being characterised by the second arm of the unlatching rocker being forward of a leading end of the deadlocking slide, the interior unlatching lever being displaceable to displace the interior unlatching cam to displace the unlatching rocker whereby to cause the second arm to contact the leading end of the deadlocking slide to displace the deadlocking slide away from deadlocking engagement to enable the engaging member to be displaced towards the fully retracted disposition while simultaneously causing the lever locking cam to be displaced from the locking disposition to free the exterior unlatching lever.

8. A lock according to claim 7, wherein the leading end of the deadlocking slide includes the engaging shoulder and an adjacently disposed ramped unlocking shoulder, and wherein the deadlocking configuration is further characterized the ramped unlocking shoulder being behind a nose portion of the second arm of the unlatching rocker.

9. A lock according to claim 8, where the unlocking shoulder is engageable by the nose portion to be displaced from the engaging member as the nose portion slides over the upwardly ramped edge defining the unlatching shoulder.

10. A lock according to claim 7, wherein the lever locking cam is displaced towards the locking configuration when the deadlocking slide is displaced to the deadlocking configuration, the locking of the exterior unlatching lever comprising displacement of a stop blade of a stop slide into a stop slot of a cupped member connected to the exterior unlatching lever, the stop slide being displaced towards the cupped member against biasing means by angular displacement of the lever locking cam, the angular displacement causing one of a pair engaging shoulders to slide over a lower substantially horizontally surface of the stop slide to enter a radially defined recess.

11. A lock according to claim 10, wherein the lever locking cam is displaced in response to operation of the locking member.

12. A lock according to claim 10, wherein the lever locking cam is displaced in response to displacement of the deadlocking slide by biasing means.

13. A lock according to claim 1, including an angularly displaceable driver member having an undisplaced disposition and being connectable to at least one remote engaging member to actuate the remote engaging member,
said driver member being displaceable towards the undisplaced disposition by displacement of an unlatching cam in an unlatching direction, said driver member being displaceable from the undisplaced disposition by displacement of an unlatching cam in the opposite direction.

14. A lock according to claim 13, wherein the pivotal axis of the diver member is substantially midway between the front and rear edges of the casing and orthogonal to the sides of the casing while the pivotal axis of the unlatching lever is parallel and rearwardly disposed of the driver member pivotal axis.

15. A lock according to claim 14, wherein the pivotal axis of the unlatching cam is within the diameter that defines the periphery of the annular driver whereby to minimize the space within the casing occupied by the driver annulus and unlatching cam subassembly.

16. A lock according to claim 13 including at least one remote engaging member vertically removed from the casing and operably connected to the driver member by a vertically elongated drive member resistant to buckling to be actuateable by unlatching lever displacement.

17. A lock according to claim 13 wherein the diver member comprises a disc-like annular driver and wherein each unlatching cam includes a drive arm that extends to occupy a peripheral drive recess of the annular driver whereby to operably connect the unlatching cam and annular driver.

18. A lock according to claim 17, including an upper and a lower remote engaging member each vertically removed from the casing, said remote engaging members being operably connected to the driver member by an upper vertically elongated drive member resistant to buckling hand a lower vertically elongated drive member resistant to buckling respectively to be simultaneously actuateable by unlatching lever displacement.

19. A lock according to claim 18, including an upper drive member connected to a first side recess in the driver annulus adjacent the peripheral edge and a lower drive member connected to a radially opposed second side recess in the driver annulus adjacent the peripheral edge, the drive members being simultaneously displaceable in opposite directions in response to driver annulus rotation.

20. A lock according to claim 19, wherein said upper drive member and lower drive member are connected to the driver annulus by an upper and a lower rectilinearly displaceable drive slide resistant to buckling h respectively, each said drive slide comprising a member resistant to buckling having at one end a rightangled return portion to mate within a side recess of the driver annulus and at the other end an externally threaded portion to mate with internal threading in an end of the corresponding drive member.

21. A lock according to claim 20, wherein the externally threaded portion comprises a substantially cylindrical fitting having an axial aperture into. which an offset extension of the drive slide extends to support the fitting.

22. A lock according to claim 21, including for each drive member an elongated flexible cable attached to the fitting for threading through the unfitted drive member so that during fitting the drive member can be slid along the cable into the frame of the wing whereupon the cable can be pulled taunt to guide the threaded end of the drive member into contact with the fitting to be rotated into threaded engagement.

23. A lock according to claim 18, wherein each drive member comprises a Bowden Cable having an inner cable having a right-angled return portion to mate within a side recess of the driver annulus peripheral edge.

24. A lock according to claim 23, wherein the side recesses for the upper and lower inner Bowden Cables are adjacently disposed and the upper and lower inner Bowden Cables displace simultaneously in the same direction.

25. A lock according to claim 5, including an angularly displaceable driver member comprising a disc-like annular driver connected to the deadlocking slide by a displaceable deadlocking slide extension and having an undisplaced disposition, said driver member being connectable to at least one remote engaging member to be able actuate the remote engaging member, and member being the driver member being displaceable towards the undisplaced disposition by displacement of the deadlocking slide from the deadlocking configuration and displaceable from the undisplaced disposition by displacement of the deadlocking slide towards the deadlocking configuration.

26. A lock according to claim 25, wherein the pivotal axis of the diver member is substantially midway between the front and rear edges of the casing and orthogonal to the sides of the casing while the pivotal axis of the unlatching lever is parallel and rearwardly disposed of the driver member pivotal axis.

27. A lock according to claim 26, including an upper and a lower remote engaging member each vertically removed from the casing, said remote engaging members being operably connected to the driver member by an upper vertically elongated drive member resistant to buckling h and a lower vertically elongated drive member resistant to buckling respectively to be simultaneously actuateable.

28. A lock according to claim 27, including an upper drive member connected to a first side recess in the driver annulus adjacent the peripheral edge and a lower drive member connected to a radially opposed second side recess in the driver annulus adjacent the peripheral edge, the drive members being simultaneously displaceable in opposite directions in response to driver annulus rotation.

29. A lock according to claim 27, wherein each drive members comprises a Bowden Cable having an inner cable having a right-angled return portion to mate within a side recess of the driver annulus peripheral edge.

30. A lock according to claim 29, wherein the side recesses for the upper and lower inner Bowden Cables are adjacently disposed and the upper and lower inner Bowden Cables displace simultaneously in the same direction.

31. A lock according to claim 13, including a driver locking slide connected to the deadlocking slide to be displaced into a driver locking recess of the driver member when the deadlocking slide is displaced to the deadlocking configuration whereby to restrain the driver member against displacement.

32. A lock according to claim 1, including a lock body mountable to a displaceable wing supported adjacent an opening and engageable means associated with an element defining in part the opening, said lock body including a casing and an engaging member supported by the casing and displaceable between a a fully displaced disposition corresponding to the engaging member and engaging means cooperating in engagement to restrain the wing against displacement in an opening direction and a fully retracted disposition in which it is not so engaged with the engageable means.

33. A lock according to claim 32, wherein the engaging member is biased towards the fully displaced disposition and is characterized by a pre-latching configuration in which it is restrained from being displaced towards the fully displaced disposition.

34. A lock according to claim 33, including an outwardly biased auxiliary bolt to cooperate with the engaging member to restrain the engaging member in the prelatching configuration, said auxiliary bolt being inwardly displaceable to preclude said engagement.

35. A lock according to claim 33, wherein the engaging member comprises a strike plate and wherein a portion of the latch bolt protrudes from the casing in the pre-latching configuration to be engaged on either side by the strike plate during latching to be inwardly displaced by the strike plate, said portion being similarly profiled on both sides, said profiling comprising a radius, curve or chamfer or other such form.

36. A lock according to claim 32, wherein the engageable means comprises a strike plate and the wing comprises a hinged door or the like.

37. A lock according to any one of claims 32 to 35, wherein the engageable means comprises a catch and the wing comprises a sliding door or the like.

38. A lock according to claim 1, wherein the engaging member comprises a rectilinearly displaceable latch bolt.

39. A lock according to claim 38, wherein the latch bolt supports at least one displaceable hooking arm having an engaging shoulder that protrudes from a side of the bolt when the bolt is fully extended.

40. A lock according to claim 1, wherein the engaging member comprises an angularly displaceable latch bolt.

41. A lock according to claim 38, wherein the engaging member comprises a drive bolt that is outwardly displaceable by operation of each unlatching lever.

42. A lock according to claim 33, including a hand operable locking member and a displaceable deadlocking slide supported within the casing and characterized by a deadlocking configuration in which a leading end of the deadlocking slide and the engaging member co-operate to restrain the engaging member from being displaced from the fully displaced position,
wherein the deadlocking slide is biased towards and displaceable into the deadlocking configuration by a deadlocking slide biasing means,
the deadlocking slide being displaceable from the deadlocking configuration by the locking cam to a spring-loaded restrained configuration where an arm of the locking cam overlaps an exit shoulder of the deadlocking slide,
the locking cam being displaceable subsequently to release the deadlocking slide to enable it to be displaced by deadlocking slide biasing means to abut the engaging member in the pre-latching configuration and where on latching to be displaced into the deadlocking configuration.

43. A lock according to claim 42, wherein the deadlocking slide includes an accelerator to displace the locking cam to overlap the exit shoulder of the deadlocking slide.

44. A lock according to claim 42, including a compression spring supported within a spring recess between a spring wing of the deadlocking slide and an end of the spring recess.

45. A lock according to claim 3, including a key operable cylinder having an angularly displaceable cylinder cam having a cylinder cam arm that protrudes into a drive recess of the deadlocking slide to operably couple the deadlocking slide and cylinder to enable the deadlocking slide to be displaced into and out of the deadlocking configuration by the cylinder.

46. A lock according to claim 45, wherein the cylinder arm is displaceable from the drive recess to abut an exit shoulder of the deadlocking slide when the lock is in a first locked configuration to restrain the deadlocking slide against displacement by means other than operation of the cylinder.

47. A lock according to claim 46, wherein the deadlocking slide includes a slide spring having a spring arm that is displaced by the cylinder cam as it departs the drive recess, said slide spring biasing the cylinder cam arm against leaving the drive recess.

48. A lock according to claim 45, including a stop pin to limit the displacement of the deadlocking slide whereby to restrict the first cam from leaving the drive recess.

49. A lock according to claim 45, wherein the cylinder comprises a double free rotation cylinder.

50. A lock according to claim 1, where the unlatching lever comprises a ball.

51. A lock according to claim 1, where the unlatching lever comprises a lever having a radially protruding extension.

52. A lock according to claim 1, wherein a fully displaced disposition embraces an operative disposition and a fully retracted disposition embraces an inoperative disposition.

53. A lock substantially as described herein with reference to and as illustrated in the accompanying drawings.

54. Complete locks for displaceable wings and improvements for locks for displaceable wings substantially as described herein with reference to and as illustrated in the accompanying drawings.
